(19) United States
(12) Patent Application Publication
(10) Pub. No.: US 2016/0032903 A1
(43) Pub. Date: Feb. 4, 2016

(54) Solar Power Plant

(71) Applicant: GOSSAMER SPACE FRAMES, Laguna Hills, CA (US)

(72) Inventor: Glenn A. Reynolds, Laguna Hills, CA (US)

(73) Assignee: GOSSAMER SPACE FRAMES, Laguna Hills, CA (US)

(21) Appl. No.: 14/702,994

(22) Filed: May 4, 2015

Related U.S. Application Data
(63) Continuation-in-part of application No. 14/331,192, filed on Jul. 14, 2014.
Application No. 14/331,192 is a continuation-in-part of application No. 13/690,762, filed on Nov. 30, 2012, now abandoned.
(60) Provisional application No. 61/987,753, filed on May 2, 2014.
(60) Provisional application No. 61/845,894, filed on Jul. 12, 2013.
(60) Provisional application No. 61/565,014, filed on Nov. 30, 2011.

(51) Int. Cl. F03G 6/06; F24J 2/10; F24J 2/34; F24J 2/04

(52) U.S. Cl. CPC F03G 6/067; F24J 2/0477; F24J 2/10; F24J 2/34

(57) ABSTRACT

A solar power plant includes a first solar reflective system for heating a first heat transfer fluid and a second solar reflective system configured for heating a second heat transfer fluid. The solar power plant may include an energy storage system having a plurality of stacked compartments, a first heat exchanger carrying the first heat transfer fluid, a second heat exchanger having carrying the second heat transfer fluid, and a third heat transfer fluid in the compartments exchanging heat with the first heat transfer fluid through the first heat exchanger and exchanging heat with the second heat transfer fluid through the second heat exchanger. The solar power plant may include a receiver system having an enclosure for holding a fourth heat transfer fluid, and a receiver in the enclosure and at least partially submerged in the fourth heat transfer fluid, the receiver including a plurality of tubes carrying the first heat transfer fluid.

### RELATED APPLICATIONS

The present application claims the benefit of U.S. Provisional Application 61/987,753, filed on May 2, 2014. The present application is a continuation in part of U.S. application Ser. No. 14/331,192, filed Jul. 14, 2014, which claims the benefit of U.S. Provisional Application Ser. No. 61/845,894, filed on Jul. 12, 2013 and is a continuation-in-part of U.S. patent application Ser. No. 13/690,762, filed on Nov. 30, 2012, which claims the benefit of U.S. Provisional Application Ser. No. 61/565,014, filed on Nov. 30, 2011. The entire disclosures of the above-noted applications are incorporated herein by reference.

### FIELD

This disclosure generally relates to concentrated solar power generation systems, and more particularly, to a solar power plant.

### BACKGROUND

Reflective solar power generation systems generally reflect and/or focus sunlight onto one or more receivers carrying a heat transfer fluid (HTF). The heated HTF is then used to generate steam for producing electricity. One type of reflective solar power generation system may use a number of spaced apart reflective panel assemblies that surround a central tower and reflect sunlight toward the central tower (hereinafter referred to as a central receiver system). Another type of reflective solar power generation system may use parabolic-shaped reflective panels that focus sunlight onto a tube receiver at the focal point of the parabola defining the reflective panels (hereinafter referred to a trough system). An HTF is heated in a trough system to about 300-400° C. (570-750° F.). The hot HTF is then used to generate steam by which the steam turbine is operated to produce electricity with a generator. In the central receiver system, an HTF is heated to about 500-800° C. (930-1480° F.).

### BRIEF DESCRIPTION OF THE DRAWINGS

FIG. 1 shows a method of generating power from a solar power plant according to one embodiment.

FIG. 2 shows a block diagram of a hybrid solar power plant according to one embodiment.

FIG. 3 shows a schematic diagram of a central receiver system according to one embodiment.

FIG. 4 shows a schematic diagram of a trough system according to one embodiment.

FIG. 5 shows a schematic diagram of a power block according to one embodiment.

FIG. 6 shows a schematic diagram of a power block according to another embodiment.

FIG. 7 shows a schematic diagram of a central receiver system according to another embodiment.

FIG. 8 shows a schematic diagram of a trough system according to another embodiment shown with the central receiver system of FIG. 7.

FIG. 9 is a schematic view of a receiver of a central receiver system.

FIG. 10 is a schematic view of a receiver of a central receiver system according to one embodiment.

FIG. 11 is a detailed schematic view of the receiver of FIG. 10.

FIG. 12 is a schematic view of a receiver assembly of a central receiver system according to one embodiment.

FIGS. 13-16 show examples of receiver tubes according to the disclosure.

FIG. 17 shows a cross-sectional view of the receiver tube according to one embodiment.

FIGS. 18 and 20 show a concentrated beam heliostat according to one embodiment.

FIG. 19 is an enlarged view of area 19 of FIG. 18.

FIGS. 21 and 23 show a concentrated beam heliostat according to one embodiment.

FIG. 22 is an enlarged view of area 22 of FIG. 21.

FIGS. 24 and 25 show a concentrated beam heliostat according to one embodiment.

FIG. 26 is a schematic view of a receiver of a central receiver system having a flow constrictor or choke according to one embodiment.

FIGS. 27-31 schematically show the operation of the flow constrictor or choke of the receiver of FIG. 26.

FIG. 32 shows a prior art receive module.

FIGS. 33 and 34 show a receiver module according to one embodiment.

FIG. 35 shows a schematic cross-sectional view of a thermal energy storage system according to one embodiment.

FIG. 36 shows a solar power plant according to one embodiment using the thermal energy storage of FIG. 35.

FIG. 37 shows a solar power plant according to one embodiment using the thermal energy storage of FIG. 35.

FIG. 38 shows a solar power plant according to one embodiment using the thermal energy storage of FIG. 35.

FIG. 39 shows a solar power plant according to one embodiment using the thermal energy storage of FIG. 35.

### DETAILED DESCRIPTION

According to the disclosure, a hybrid solar power plant may include a plurality of solar power generation systems which may be operatively coupled to produce electricity from solar energy. Each of the plurality of solar power generation systems may heat a corresponding heat transfer fluid (HTF) to a certain temperature range within an overall operating temperature range of the hybrid solar power plant. The operating temperature range of each of the solar power generation systems may be different than or have some overlap with the operating temperature ranges of the other solar power generation systems. Accordingly, as described in detail by the examples below, the hybrid solar power plant may generate steam by each power generation system heating a corresponding HTF to within a certain temperature range of the overall temperature range of the hybrid solar power generation system and contributing to increasing the operating temperature of the hybrid solar power plant to a certain or preferred operating temperature or a maximum operating temperature.

The hybrid solar power plant may include one or more central receiver systems, one or more trough systems, one or more dish-type reflective systems and/or other types of reflective systems by which solar radiation is focused on a region to heat one or more HTFs, which are then used to generate steam to operate a steam turbine to generate electricity with a steam generator. A hybrid solar power generation system having a central receiver system and a trough system is described in detail below. However, any number and/or types of solar power generation systems may be used to provide a hybrid solar power generation systems according to the disclosure.

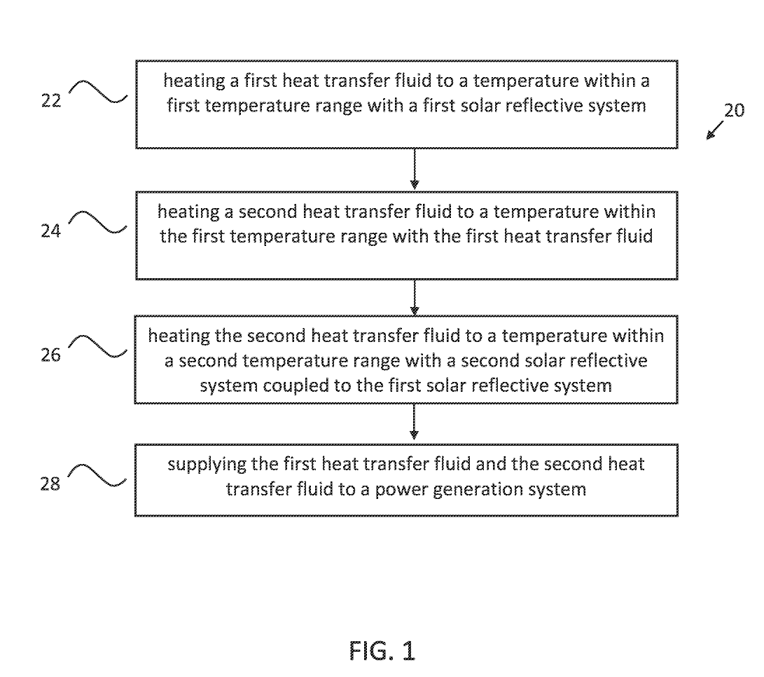

Referring to FIG. 1, a method 20 of generating heat, power and/or electricity from solar energy includes heating a first heat transfer fluid to a temperature within a first temperature range with a first solar reflective system (block 22), and heating a second heat transfer fluid to a temperature within the first temperature range with the first heat transfer fluid (block 24). The method 20 further includes heating the second heat transfer fluid to a temperature within a second temperature range with a second solar reflective system coupled to the first solar reflective system (block 26), and supplying the first heat transfer fluid and the second heat transfer fluid to a power generation system (block 28).

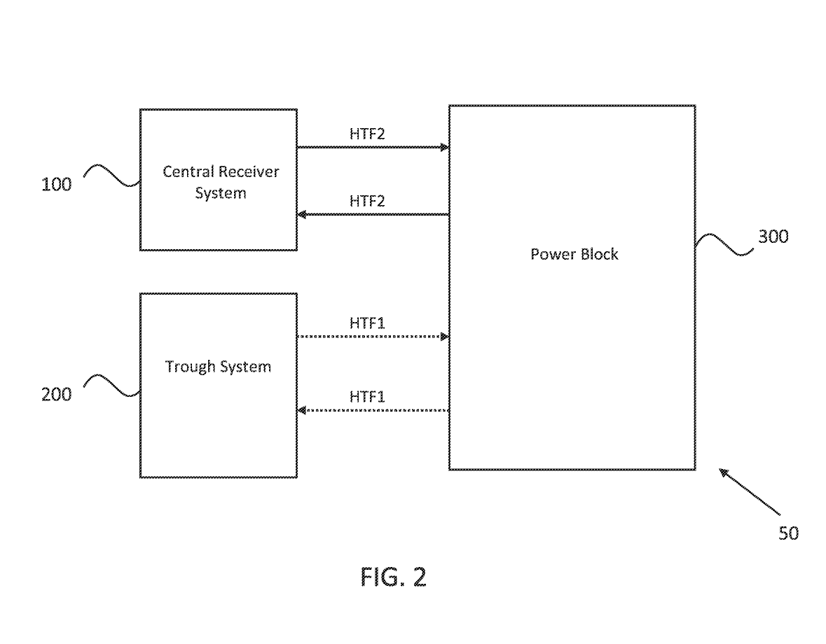

FIG. 2 shows a block diagram of a hybrid solar power plant 50 (hereinafter referred to as the hybrid plant 50) according to one embodiment. The hybrid plant 50 includes a central receiver system 100, which may be also referred to as a first solar reflective system, a solar trough system 200 (hereinafter referred to the trough system 200), which may be also referred to as a second solar reflective system, and a power block 300, which may be referred to as a power generation system, all of which are operatively coupled to produce electricity from solar energy. The trough system 200 uses the energy of the sun to heat a first heat transfer fluid (HTF1) to about 300-400° C. (570-750° F.), i.e., a first temperature range. The central receiver system 100 uses the energy of the sun to heat a second heat transfer fluid (HTF2) to about 500-800° C. (930-1480° F.), i.e., a second temperature range. As shown in FIG. 2, both the hot HTF1 and the hot HTF2 are transferred to the power block 300. As described in detail below, the heat in the HTF1 and the HTF2 are used in the power block to generate electricity. The cooled HTF1 and HTF2, which are also referred to herein as the cold HTF1 and the cold HTF2 are returned to the trough system 200 and the central receiver system 100, respectively, to repeat the above-described cycle.

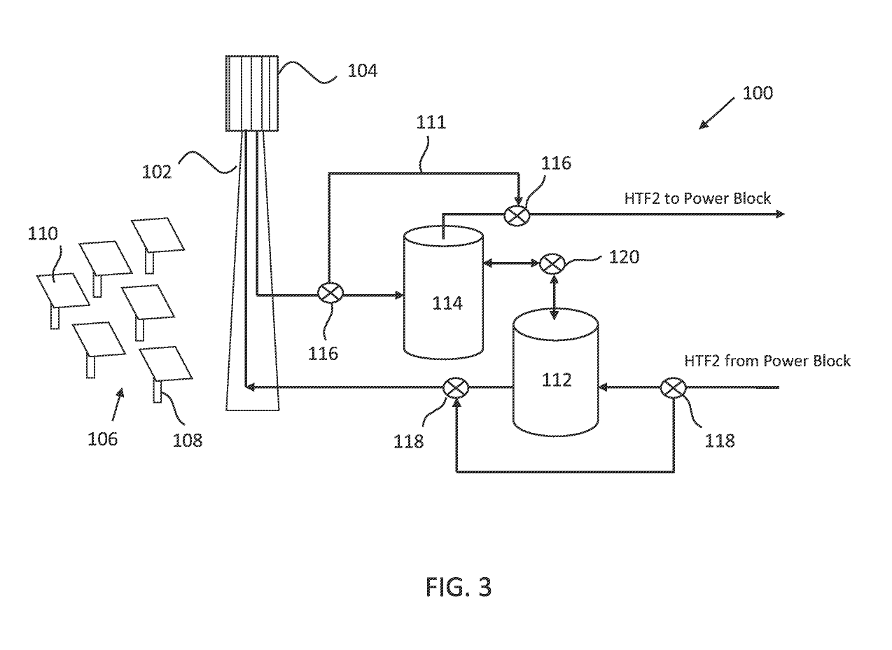

FIG. 3 is a schematic diagram of an exemplary central receiver system 100 according to one embodiment. The central receiver system 100 includes a tower 102 and a receiver 104 positioned at or near the top of the tower 102. The tower 102 is typically positioned at the center of a plurality of reflector assemblies 106, which are arranged in a rectangular, a circular, or other configuration around the tower 102. Each reflector assembly 106 includes a mounting pole or a pylon 108 that is fixed to the ground and a reflective surface 110, which directs and generally focuses sunlight onto the receiver 104. Each reflector assembly 106 also includes a heliostat (not shown) which controls the position of the reflective surface 110 so as to track the position of the sun. Thus, all of the reflective surfaces 110 track the position of the sun and direct and generally focus sunlight onto the receiver 104.

The central receiver system 100 includes an HTF2 loop 111, by which the HTF2 is carried through various components of the central receiver system 100 as described herein. The cold HTF2 is transferred from a cold tank 112 to a plurality of tubes (not shown) inside the receiver 104. The cold HTF2 is then heated in the receiver 104 as a result of receiving focused sunlight from the reflector assemblies 106. The hot HTF2 is then transferred from the receiver 104 to a hot tank 114. The HFT2 may be a salt or salt compound, which is in liquid form in both the cold and hot states. In the cold state, the HFT2 has a temperature that is above the freezing point of HTF2. Preferably, however, the HTF2 may have a temperature that is greater than the freezing point of HTF2 by a large margin to prevent freezing of the HTF2 in the central receiver system 100.

The hot tank 114 and the cold tank 112 function as energy storage devices. The hot HTF2 from the hot tank 114 is supplied to the power block 300, where the heat in the hot HTF2 is used to generate electricity as described in detail below. After the heat from the hot HTF2 is extracted to generate electricity, the cold HTF2 from the power block 300 returns to the cold tank 112 to repeat the above-described cycle. However, the hot HTF2 may be supplied directly to the power block 300 from the receiver 104 by bypassing the hot tank 114 with valves 116. Similarly, the cold HTF2 returning from the power block 300 may be directly transferred to the receiver 104 by bypassing the cold tank 112 with valves 118. The hot tank 114 and the cold tank 112 can transfer HTF2 to each other in order to regulate and control the temperature of the HTF2 in the HTF2 loop 111. The transfer of HTF2 to and from the cold tank 112 and the hot tank 114 is controlled by the valve 120.

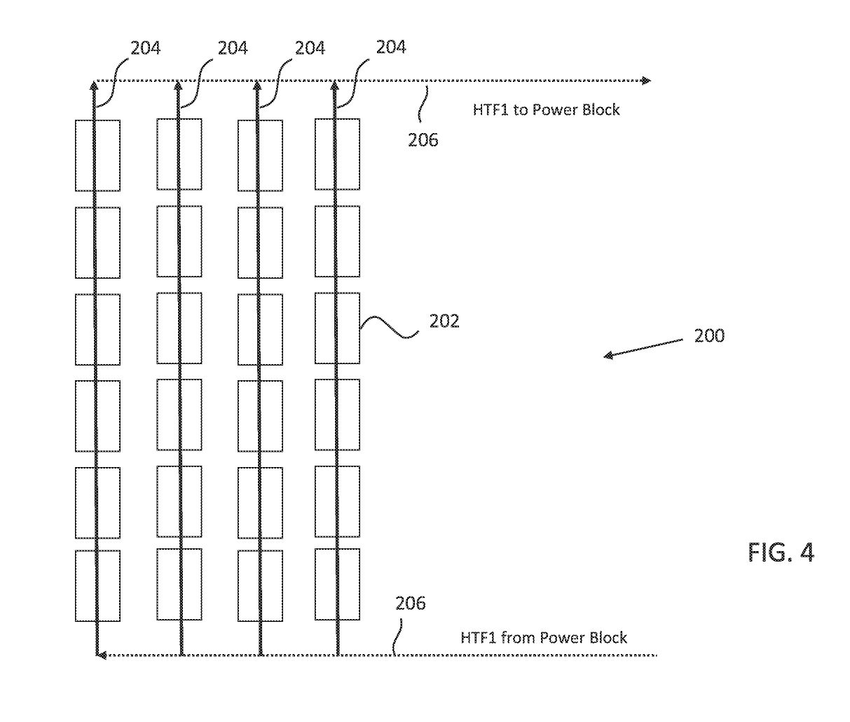

FIG. 4 is a schematic diagram of trough system 200 according to one embodiment. The trough system 200 includes a plurality of parabolic reflective surfaces 202 that may be arranged in rows. Each row of reflective surfaces 202 includes a receiver tube 204 that is positioned along the focal lines of the reflective surfaces 202. A control system (not shown) rotates the reflective surfaces 202 during the day to track the position of the sun. Accordingly, the reflective surfaces 202 focus sunlight onto the corresponding receiver tubes 204 throughout the day. The trough system 200 includes an HTF1 loop 206, by which the HTF1 is carried through various components of the trough system 200 as described herein. The HTF1 may be synthetic oil. The cold HTF1 is supplied to the receiver tubes 204 from the HTF1 loop 206. The resulting hot HTF1 is returned to the HTF1 loop 206. The hot HTF1 is supplied to the power block 300, in which the heat from the hot HTF1 is used to generate electricity as described in detail below. After using the hot HTF1 to generate electricity, the power block 300 returns the cold HTF1 to the receiver tubes 204 to repeat the above-described cycle.

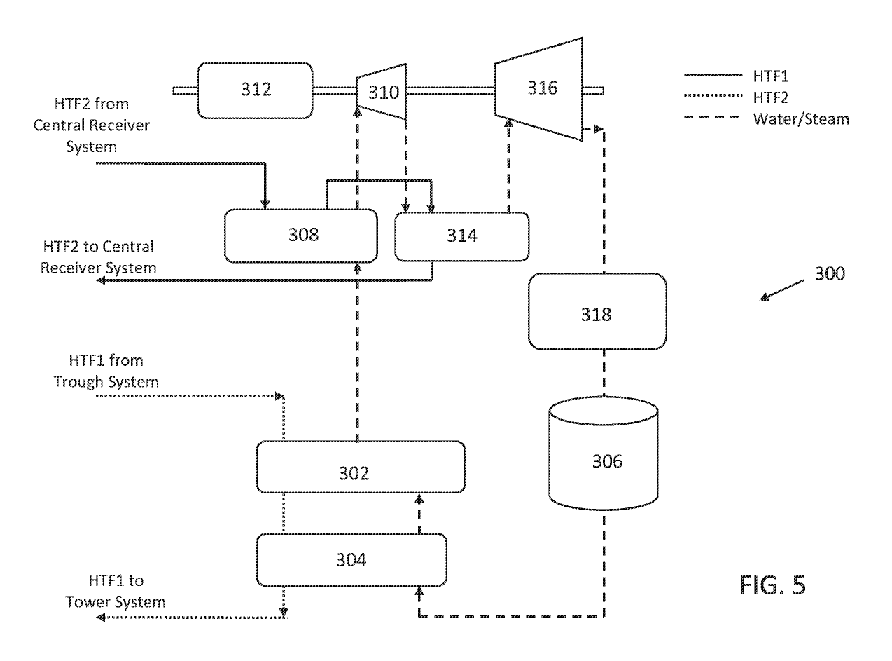

FIG. 5 is a schematic diagram of a power block 300 according to one embodiment. The power block 300 includes a steam generator 302 that receives the hot HTF1 from the HTF1 loop 206 and heated water from a preheater 304. The stream generator 302 may also receive water that is not preheated. The steam generator 302 uses the thermal energy in the HTF1 to convert the water or the heated water to steam, which may be referred to herein as the first steam. The HTF1 downstream of the steam generator 302 is used in the preheater 304 to heat the water that is supplied from a condensate tank 306 to the preheater 304.

The first steam from the steam generator 302 is supplied to a superheater 308. The hot HTF2 is supplied from the central receiver system 100 to the superheater 308, which uses the thermal energy of the HTF2 to further heat the first steam to provide a higher energy steam, which may be referred to herein as a second steam. The second steam is then supplied to a steam turbine 310, which operates a generator 312 to produce electricity. The steam turbine 310 may be a high pressure steam turbine. The first steam may be saturated steam or wet steam, superheated steam, or a combination of wet steam and superheated steam. The second steam may be saturated steam or wet steam, superheated steam, or a combination of wet steam and superheated steam. However, the second steam has higher energy than the first steam.

The steam downstream of the steam turbine 310 is transferred to a reheater 314, which uses the thermal energy of the HTF2 downstream of the superheater 308 to reheat the steam. The reheated steam is then supplied to a steam turbine 316 to produce electricity. The steam turbine 316 may be a low pressure steam turbine. The steam turbine 310 and the steam turbine 316 may define stages or cycles of a single steam turbine. The cooled steam downstream of the steam turbine 316 is condensed to water in a condenser 318 and is then transferred to the condensate tank 306 to repeat the above-described power block cycle.

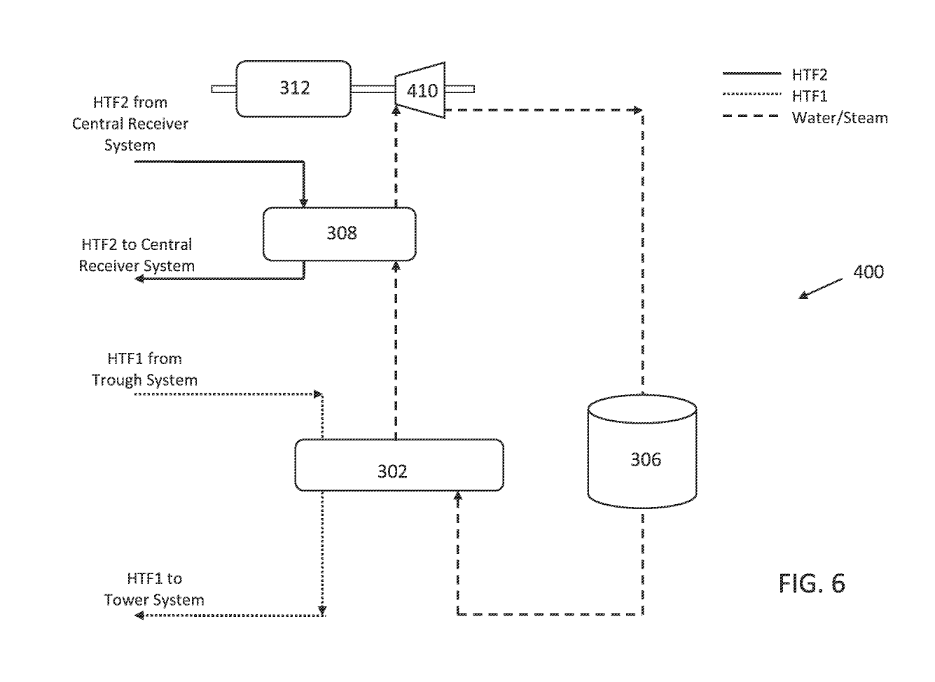

FIG. 6 is a schematic diagram of a power block 400 according to another embodiment. The power block 400 may have similar components as the power block 300. Therefore, similar components are referred to with the same reference numbers. Power block 400 represents a generally basic power block that may be used in the hybrid plant 50. The power block 400 includes a steam generator 302, a superheater 308, a steam turbine 410, a generator 312, and a condensate tank 306. The steam generator 302 receives the hot HTF1 from the HTF1 loop 206 and uses the thermal energy in the hot HTF1 to convert water supplied from the condensate tank 306 to the first steam. The first generated steam from the steam generator 302 is supplied to a superheater 308. Hot HTF2 is supplied from the central receiver system 100 to the superheater 308, which uses the thermal energy of the HTF2 to generate the second steam. The second steam is then supplied to the steam turbine 410, which operates a generator 312 to produce electricity. The cool steam downstream of the steam turbine 410 is then transferred to the condensate tank 306 to repeat the above-described power block cycle. Power blocks 300 and 400 represent two exemplary power blocks according to the disclosure. Any power block configuration may be constructed according to the disclosure that is similar to the power block 300 or 400 and/or includes any one or more of the components of the power blocks 300 and 400.

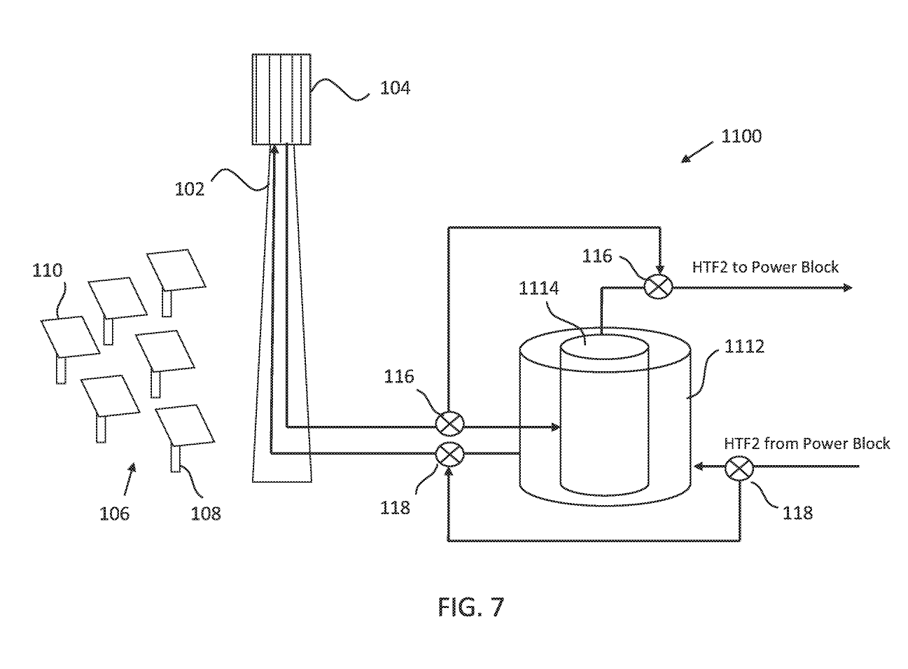

FIG. 7 shows a central receiver system 1100 according to another embodiment, which is referred to herein as the central receiver system 1100. The central receiver system 1100 is similar in some respects to the central receiver system 100. Therefore, the same parts are referred to with the same reference numbers and a description of these parts is not provided for brevity.

The central receiver system 1100 includes a cold tank 1112 for storing the cold HTF2 and a hot tank 1114 for storing the hot HTF2. The tanks 1112 and 1114 are arranged so that the cold HTF2 surrounds at least a portion of the hot tank 1114. In the example of FIG. 7, the cold tank 112 is a hollow cylinder in which the hot tank 1114 is nested. Accordingly, the cold tank 1112 substantially or entirely surrounds the hot tank 1114. The cold HTF2 of the cold tank 1112 may function as insulation for the hot HTF2 in the hot tank 1114. Additionally, any heat that is lost from the hot HTF2 can be mostly transferred to or captured by the cold HTF2 in the cold tank 1112. Accordingly, the overall heat loss in the HTF2 is reduced and the overall heat in the hot tank 1114 and the cold tank 1112 is conserved.

FIG. 8 shows a solar trough system 1200 according to another embodiment, which is referred to herein as the trough system 1200. The trough system 1200 is similar in some respects to the trough system 200. Therefore, the same parts are referred to with the same reference numbers and a description of these parts is not provided for brevity. FIG. 8 also shows the central tower system 1100 to illustrate the operation of the solar trough system 1200 and the central tower system 1100 and the hybrid plant 50. However, the central tower system 100 of FIG. 3 can also operate with the solar trough system 1200 in the hybrid plant 50.

The trough system 1200 includes an HTF2 heater 1210. The HTF2 heater 1210 receives cold HTF2 from the cold tank 1112 or 112 (not shown), heats the HTF2 and transfers the heated HTF2 to the hot tank 1114 or 114 (not shown) and/or back to the cold tank 1112 or 112. The heater 1210 receives hot HTF1 from the HTF1 loop 206. The hot HTF1 is used in the heater 1210 to heat the HTF2. The heater 1210 may provide heating of the HTF2 with the HTF1 when a hybrid plant according to the disclosure starts operations for the first time. Furthermore, the heater 1210 may maintain the temperature of the cold HTF2 above the freezing point of HTF2 if necessary. For example, during maintenance of the central receiver system 100 or 1100, i.e., when the central receiver system 100 or 1100 is not operational, the HTF2 can be heated with the heater 1210 to prevent the HTF2 from freezing. In the event that the HTF2 is frozen in all or parts of the central tower system 100 or 1100, heated air can be injected into various parts including pipes or tubes of the central tower system 100 or 1100 to melt the frozen HTF2. The air can be heated with the heater 1210. However, under certain circumstances, the hot tank 114 or 1114 may have a supply of hot HTF2, by which the air can be heated for melting the HTF2 in the pipes, tubes or other parts of the central tower system 100 or 1100. As shown in FIG. 8, the trough system 1200 may include two valves 1220, by which the operation of the heater 120 and/or the amount of HTF1 used for the heater 1210 may be controlled.

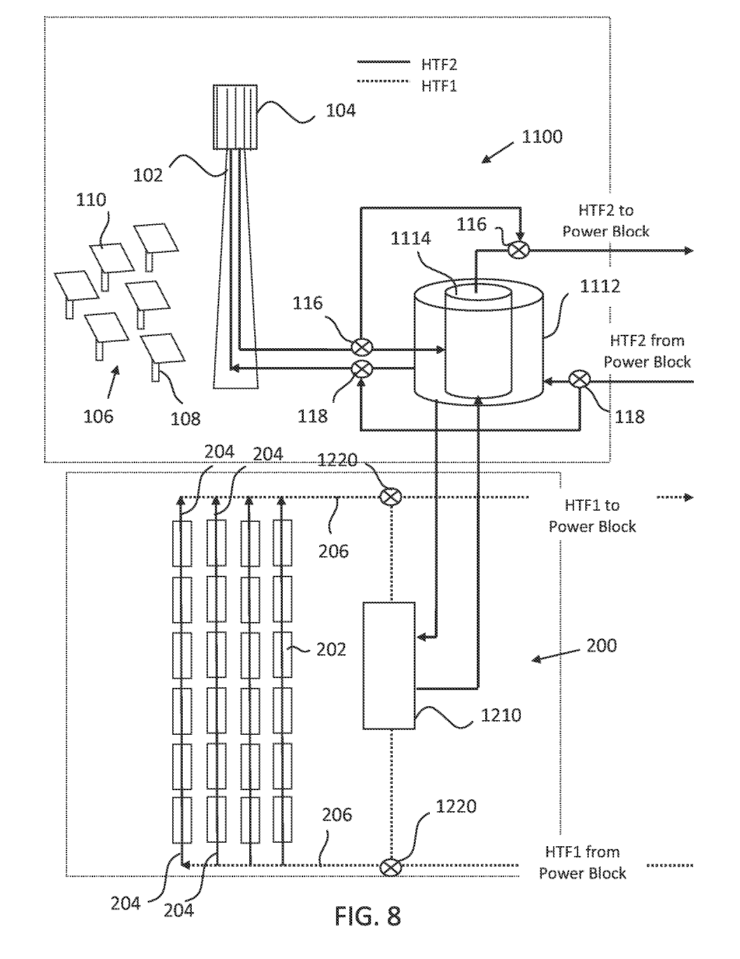

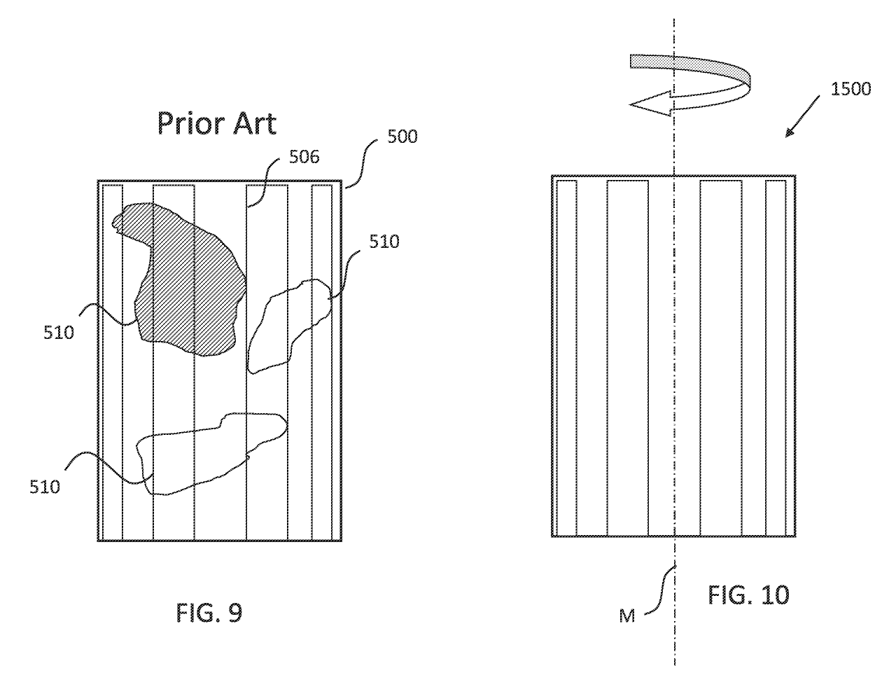

Referring to FIG. 9, a typical receiver 500 of a central receiver system is shown. The receiver 500 is generally cylindrical and includes tubes 506 onto which sunlight is focused from a large field of reflector panels. The tubes 506 transfer the heat from the focused sunlight to the HTF2 that flows through the tubes 506. The focusing areas of the reflectors on the receiver 500 may not be uniformly distributed onto the receiver 500 according to the position of the reflectors in the reflector field because of: irregularities in the reflector field; a number of inoperative reflectors at various locations in the field; inability of several reflectors to accurately focus sunlight onto the receiver; and/or other possible reasons, the receiver may experience regions of heat flux. Accordingly, certain areas of the receiver 500 may experience very high heat, while other areas may experience lower heat. For example, FIG. 9 shows regions 510 as receiving a disproportionate amount of focused sunlight from the reflector field as compared to the remaining regions of the receiver 500.

FIG. 10 shows a receiver 1500 according to one embodiment. The receiver 1500 rotates about the receiver's central axis M to uniformly distribute the regions of heat flux, i.e., regions 510 shown in FIG. 8. Thus, the same locations on the receiver may not experience the regions 510 of FIG. 8 due to the rotation of the receiver. Therefore, the HTF2 flowing through the receiver 1500 is uniformly heated. Furthermore, damage to the receiver 1500 as a result of extreme heat at the regions 510 is prevented.

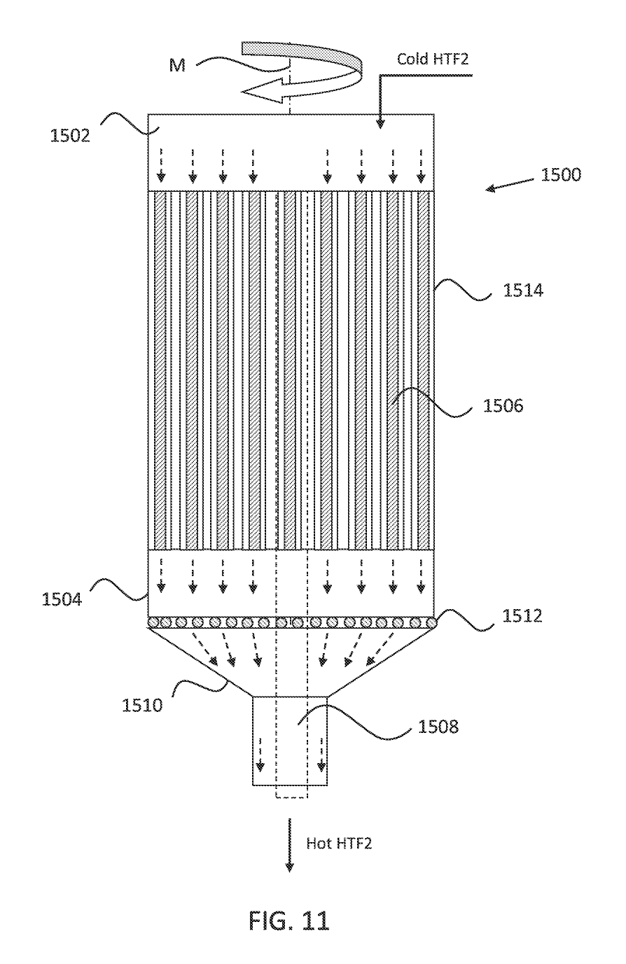

FIG. 11 shows the receiver 1500 in more detail. The receiver may include a distribution tank 1502, a drain tank 1504, and a plurality of receiver tubes 1506 that provide fluid communication between the distribution tank 1502 and drain tank 1504. The receiver tubes 1506 are connected to and supported by the distribution tank 1502 and the drain tank 1504. The distribution tank 1502, the drain tank 1504 and the receiver tubes 1506 rotate about the center axis M. In the example of FIG. 11, the distribution tank 1502 and the drain tank 1504 are mounted on a rotating shaft 1508. However, other methods of rotating the distribution tank 1502 and the drain tank 1504 may be used. The receiver 1500 includes a collection sump 1510 that may be fixed, i.e., may not rotate. The drain tank 1504 is mounted on the collection sump 1510 with bearings or rollers 1512 to allow rotation of the drain tank 1504 relative to the collection sump 1510. In other embodiments, the drain tank 1504 may be replaced with a plate (not shown) that provides mounting of the tubes 1506 thereon. Accordingly, the HTF2 may directly drain from the tubes 1506 to the collection sump 1510.

The bottom of the distribution tank 1502 includes a plurality of openings or apertures (not shown). Each opening may be connected to a corresponding receiver tube 1506. Similarly, the top of the drain tank 1504 includes a plurality of openings or apertures. Each opening may be connected to a corresponding receiver tube 1506. Cold HTF2 is supplied to the distribution tank 1502 from a cold tank or directly from a power block. The cold HTF2 flows from the distribution tank 1502 through each receiver tube 1506, by which the HTF2 is heated. The hot HTF2 then flows into the drain tank 1504 from the receiver tubes 1506. The collection sump 1510 collects the hot HTF2 from the drain tank 1504. The hot HTF2 is then transferred to a hot tank or directly to a power block from the collection sump 1510.

FIG. 12 shows a receiver assembly 1600 according to another embodiment. The receiver assembly 1600 may include multiple single receivers. For example, each receiver of the receiver assembly 1600 may be similar to the receiver 1500 described above. Accordingly, each receiver in FIG. 12 is referred to as receiver 1500. The receiver assembly 1600 rotates about a central axis M to uniformly distribute the regions of heat flux. The receiver assembly 1600 includes a distribution tank 1602, a drain-distribution tank 1604, a drain tank 1605, and a plurality of receiver tubes 1606 that provide fluid communication between the distribution tank 1602, the drain-distribution tank 1604 and the drain tank 1605. The receiver tubes 1606 may be connected to and supported by the distribution tank 1602, the drain-distribution tank 1604 and/or the drain tank 1605. The distribution tank 1602, the drain-distribution tank 1604, the drain tank 1605 and the receiver tubes 1606 rotate about the center axis M. In the example of FIG. 12, the distribution tank 1602, the drain-distribution tank 1604 and the drain tank 1605 are mounted on a rotating shaft 1608. However, other methods of rotating the distribution tank 1602, the drain-distribution tank 1604 and the drain tank 1605 may be used. The receiver assembly 1600 includes a collection sump 1610 that is fixed, i.e., does not rotate. The drain tank 1605 is mounted on the collection sump 1610 with bearings or rollers 1612 to allow rotation of the drain tank 1605 relative to the collection sump 1610. In other embodiments, the drain tank 1605 may be replaced with a plate (not shown) that provides mounting of the tubes 1606 thereon. Accordingly, the HTF2 may directly drain from the tubes 1606 to the collection sump 1610.

The bottom of the distribution tank 1602 includes a plurality of openings or apertures (not shown). Each opening may be connected to a corresponding receiver tube 1606 of the upper receiver 1500. The top of the drain-distribution tank 1604 includes a plurality of top openings or apertures. Each top opening may be connected to a corresponding receiver tube 1606 of the upper receiver 1500. The bottom of the drain-distribution tank 1604 also includes a plurality of bottom openings or apertures. Each bottom opening may be connected to a corresponding receiver tube 1606 of the lower receiver 1500. Cold HTF2 is supplied to the distribution tank 1602 from a cold tank or directly from a power block. The cold HTF2 flows from the distribution tank 1502 though each receiver tube 1606 of the upper receiver 1500, by which the HTF2 is heated. The hot HTF2 then flows through the receiver tubes 1606 of the low receiver 1500 from the drain-distribution tank 1604 so that the HTF2 is further heated. The collection sump 1610 collects the hot HTF2 from the drain tank 1605. The hot HTF2 is then transferred to a hot tank or directly to a power block from the collection sump 1610.

A receiver assembly may include any number of receivers. Each receiver 1500 may be similar such that each receiver may be transported to an assembly site and assembled to form the receiver assembly 1600. The position of each receiver 1500 in the receiver assembly 1600 may be interchangeable. Accordingly, the top receiver 1500 may include the distribution tank 1602 and the bottom receiver 1500 may include the drain tank 1605, while all other receivers 1500 in between the top receiver and the bottom receiver may include drain-distribution tanks 1604. By providing a modular receiver assembly 1600, any size receiver tower may be assembled on-site rather than having a large receiver assembly be constructed off-site and transported to the power plant site. Therefore, depending on the various requirements of a solar power plant, a receiver assembly may be constructed according to the disclosure to include any number of receivers 1500.

The receiver tubes 1506 and 1606 may be similar to receiver tubes that are used in typical receivers of central receiver systems. In one embodiment as shown in FIGS. 11 and 12, each receiver tube 1506 and 1606 may be encased in a glass enclosure or tube 1514 and 1614 to reduce convention cooling of the receiver tube 1506 or 1606, respectively. The space between the glass tube 1514 and 1614 and the receiver tube 1506 and 1606, respectively, may be a vacuum. However, to reduce the cost of manufacturing the receiver tubes 1506 and 1606 and the glass tube 1514 and 1614, the space may be air filled or filled with other gases.

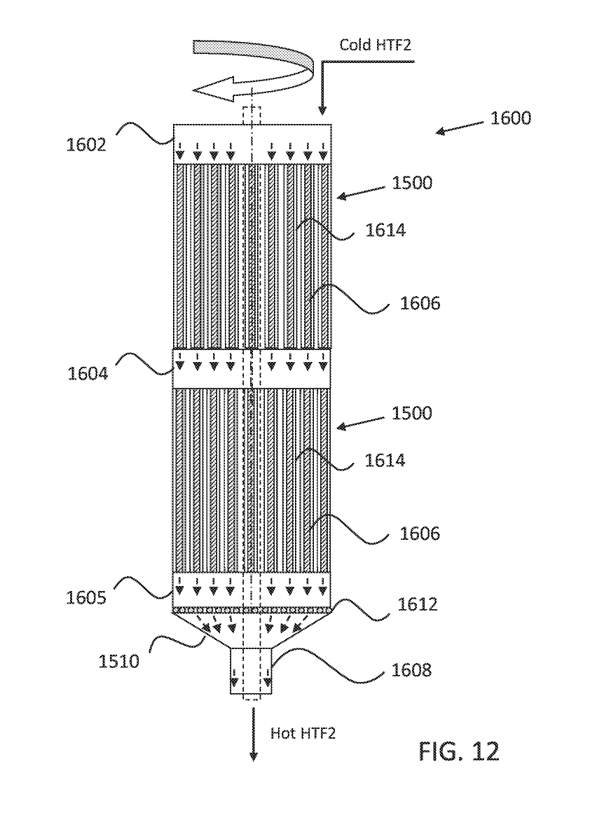

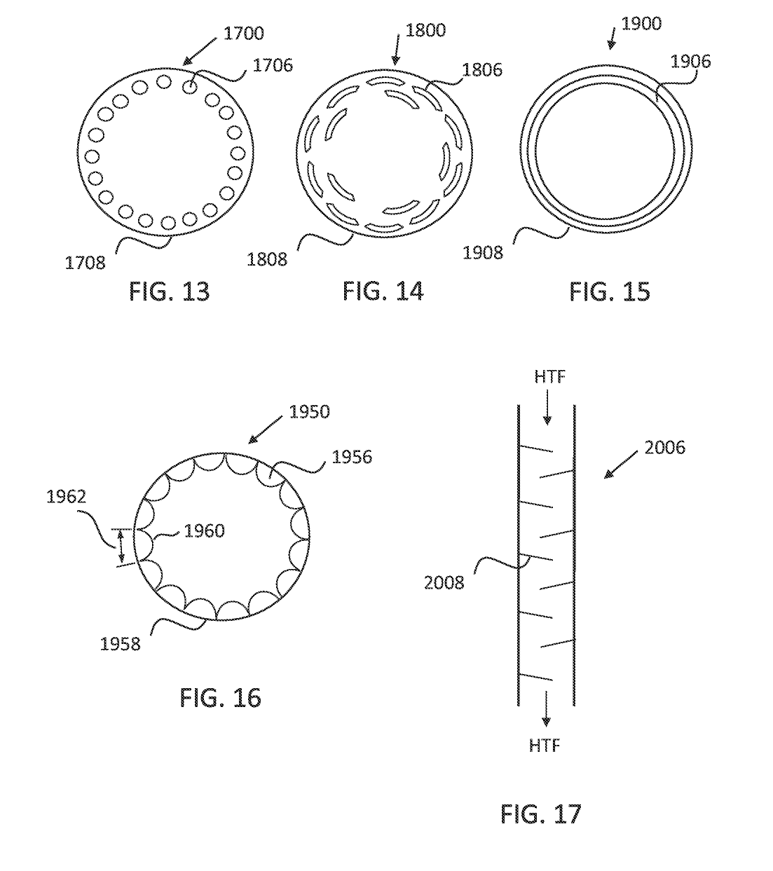

FIG. 13 shows another example of receiver tubes. A receiver 1700 may include a plurality of receiver tubes 1706. To reduce convection cooling of the receiver tubes 1706, all of the receiver tube 1706 may be encased by a glass tube 1708. Thus, instead for each receiver tube being encased in a glass tube, all of the receiver tubes 1706 are encased by a glass tube 1708.

FIG. 14 shows another example of receiver tubes. A receiver 1800 may include a plurality of receiver tubes 1806 that are non-cylindrical to increase the surface area of each receiver tube 1806. In the example of FIG. 14, each receiver tube 1806 defines a section of an annular tube. Accordingly, a larger surface area of each receiver tube 1806 may be exposed to solar radiation. Furthermore, the receiver 1800 may include additional receiver tubes 1806 that are staggered behind the first row of receiver tubes 1806 to absorb any solar radiation that may be reaching the interior of the receiver 1800 from gaps between the first row of receiver tubes 1806. To reduce convection cooling of the receiver tubes 1806, all of the receiver tubes 1806 may be encased by a glass tube 1808.

FIG. 15 shows another example of receiver tubes. A receiver 1900 may include a single annular receiver tube 1906. To reduce convection cooling of the receiver tube 1906, the receiver 1900 may include a glass tube 1908 that encases the receiver tube 1906. Thus, according to the example of FIG. 15, one annular receiver tube 1906 may be used instead of a plurality of receiver tubes.

FIG. 16 shows another example of receiver tubes. A receiver 1950 may include a plurality of receiver tubes 1956, where each receiver tube 1956 is partly defined by the perimeter wall 1958 of the receiver 1950. According to one example shown in FIG. 16, each receiver tube 1956 may be defined by half of a cylinder 1960 and a section 1962 of the perimeter wall 1958. The receiver tubes 1956 may be interconnected along the length of the perimeter wall 1958 or may carry heat transfer fluid independent of each other. To reduce convection cooling of the receiver tubes 1958, the perimeter wall 1958 may be encased by a glass tube (not shown).

FIG. 17 shows a cross-section of a receiver tube 2006 according to one embodiment. As HTF flows through tube 2006, it is heated by the walls of the tube 2006. To maximize conduction of heat from the walls of the tube 2006 to the HTF, the tube 2006 may include a plurality of baffles 2008 that may slow the flow rate of the HTF through the tube 2006. The baffles 2008 may be in any configuration. In the example of FIG. 17, the baffles 2008 are formed by plates that extend from the walls of the tube 2006 toward the center of the tube 2006. Furthermore, the baffles 2008 are staggered so as to extend the length of the path of the HTF flowing through the tube 2006. The baffles 2008 of FIG. 17 represent only one example of an internal structure of the tube 2006 for slowing the flow rate of HTF through the tube 2006. Accordingly, any type of internal structure is possible, such as mesh screens, plates with a plurality of apertures, or funnel shaped structures.

In another embodiment, receiver tubes of a central receiver may not be linear (not shown) in order to increase the path of the HTF flowing through the tubes. For example, the tubes may be curved, have a zigzag shape, or any other shape by which the path of the HTF flowing through the tubes from the top of the receiver to the bottom of the receiver can be increased.

A trough system may be less costly to manufacture, operate and maintain than a central receiver plant. A trough system may provide saturated steam or a combination of superheated steam and saturated steam from hot HTF1 as described above. However, a trough-type plant may be unable to provide mostly superheated steam. Superheated steam may provide about 15% increased efficiency in steam turbine operation as compared to saturated steam. Although a central receiver system can generate superheated steam from HTF2 as described above, central receiver systems are more costly to manufacture, operate and/or maintain. For example, salt is typically used as HTF2 in a central receiver system. Because salt freezes at a relatively high temperature, a central receiver system must maintain the temperature of the HTF2 well above the freezing point during short or extended non-operative periods. In a trough system, however, synthetic oil is typically used as the HTF1, which freezes at an extremely low temperature that is well below any temperature encountered during the operation of the plant. According to embodiments of the hybrid solar plant, a trough system may be used to generate saturated steam or a combination of saturated steam and superheated steam, while a central receiver system is used to generate superheated steam. Thus, the trough system is used to provide around 75% of the heat for the hybrid plant, while the central receiver system is used to provide the remaining 25% of the heat to generate superheated steam from water. Therefore, as compared to a central receiver system, the hybrid solar plant of the disclosure can have a scaled-down central receiver system while generating the same amount of electricity. Furthermore, as compared to a trough system, the hybrid solar plant of the disclosure can produce superheated steam, which is more efficient for producing electricity than saturated steam. Therefore, overall system efficiency is increased while system complexity and costs are reduced.

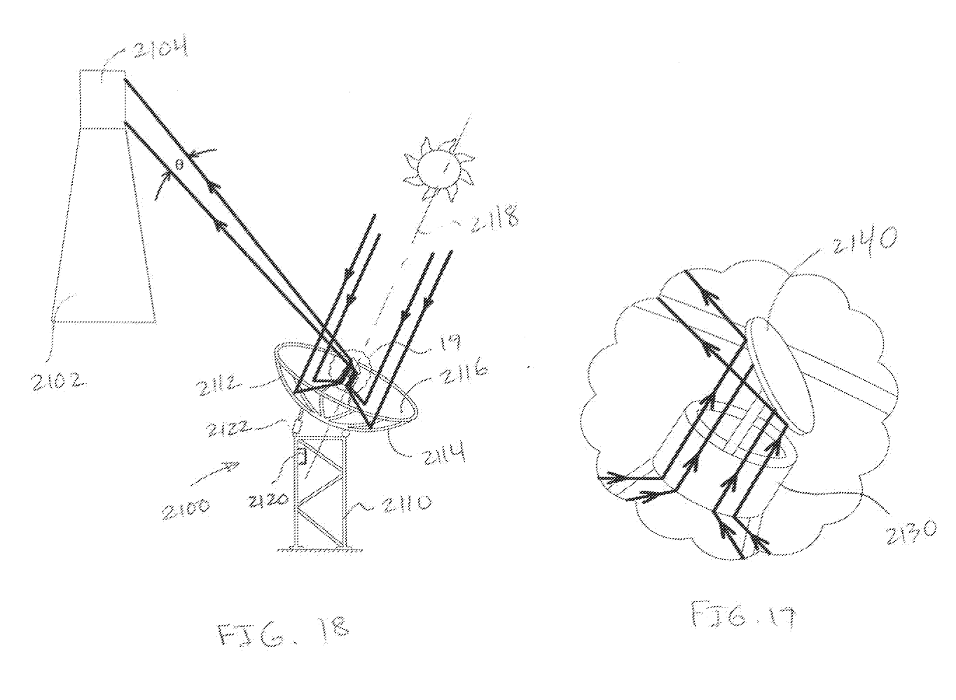

Referring to FIGS. 18 and 20, a directed beam heliostat 2100 (hereinafter referred to as heliostat 2100) according to one embodiment is shown. The heliostat 2100 may be used with any type of central receiver system having single or multiple towers with one or more receivers on each tower. Accordingly, the heliostat 2100 may also be used with any of the disclosed solar power generation systems. In the example of FIGS. 18 and 20, a tower 2102 is shown having a receiver 2104, which may be any type of receiver or a receiver according to the disclosure.

The heliostat 2100 includes a fixed base or support 2110, onto which a primary reflector 2112 assembly is rotatably mounted. The primary reflector assembly 2112 includes a frame 2114 and a parabolic-shaped reflector 2116 having a reflector axis 2118. The reflector 2116 focuses solar rays that are parallel to the reflector axis onto a theoretical focal point on the reflector axis 2118. In practice, however, the focal point may be a small region generally on or proximate to the reflector axis. The reflector 2116 may be pointed toward the sun such that the reflector axis 2118 is generally pointed toward the sun in order to maximize the amount of parallel solar rays captured by the reflector 2116. The heliostat 2100 includes a control system, which may include a controller 2120 and a driver 2122. The controller 2120 tracks the position of the sun and sends commands to the driver 2122 to move the reflector assembly 2112 so that the reflector 2116 is generally pointed toward the sun during the operation of the heliostat 2100. The controller 2120 may include electronic circuits, one or more processors, volatile and/or non-volatile memory, wired or wireless input/output ports and other hardware components that may be operated by a control algorithm to control the movement of the reflector assembly 2112. The driver 2122 may be hydraulic, be pneumatic, and/or be electric, use various types of gears and/or pulleys, be magnetic, and/or include any type of mechanical and/or electronic system that can translate command signals from the controller 2120 into motion of the reflector assembly 2112. In the disclosed examples, the driver 2122 may be a two-axis driver, by which the reflector assembly 2112 is rotated to adjust elevation and an azimuth of the reflector 2116. In other words, the control system operates as a two-axis tracker. The apparatus, methods, and articles of manufacture described herein are not limited in this regard.

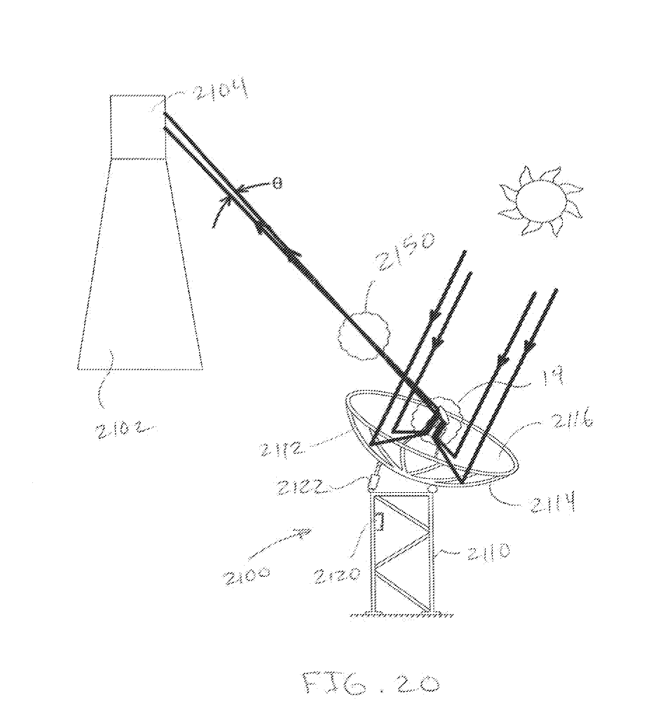

Referring to FIG. 19, the heliostat 2100 further includes a collimator 2130, which is mounted at the focal point of the reflector 2116 or proximate to the focal point of the reflector 2116. The collimator 2130 receives the converging solar rays being focused onto the focal point of the reflector 2116 and redirects the converging solar rays into generally parallel solar rays. The collimator 2130 may be constructed with one or more Fresnel lenses, lenticular lenses, curved reflectors, and/or other optical devices. A secondary reflector 2140 is mounted upstream of the collimator 2132 to receive the parallel solar rays. The secondary reflector 2140 operates with a 2-axis tracking control system similar to the control system of the reflector assembly 2112 so that the secondary reflector 2140 can reflect and direct the parallel solar rays toward the receiver 2104 during the day when the reflector assembly 2112 is tracking the position of the sun. As shown in FIG. 19, the curvature of the secondary reflector 2140 may be determined so that the solar rays reflected from the secondary reflector 2140 form a beam having a beam angle θ. The beam angle θ may be determined so that based on the distance of the heliostat from the tower 2102, the beam reflected from the secondary reflector 2140 generally strike at least a portion of or the receiver 2104 or the entire receiver 2104.

A heliostat 2100 may be positioned far from the receiver 2104 such that the beam angle θ may become too large when the reflected solar rays reach the receiver 2104. Accordingly, only a portion of the reflective solar rays may strike to receiver 2104. According to the embodiment shown in FIG. 20, the secondary reflector 2140 may be configured in size and curvature so that the reflective solar rays intersect at a region 2150 between the secondary reflector 2140 and the receiver 2104. Accordingly, a heliostat 2100 may be positioned far from the receiver 2104 and yet provide a beam angle θ for the beam such that most of the reflective solar rays strike at least a portion or the entire receiver 2104. According to one example, the distance of the heliostat 2100 shown in FIG. 20 may be twice as large as the distance of the heliostat 2100 of FIG. 18 from the tower 2102. Therefore, the noted crossbeam configuration shown in FIG. 20 allows heliostats 2100 that use the crossbeam configuration to be placed far from the tower 2102 so as to provide a large heliostat field.

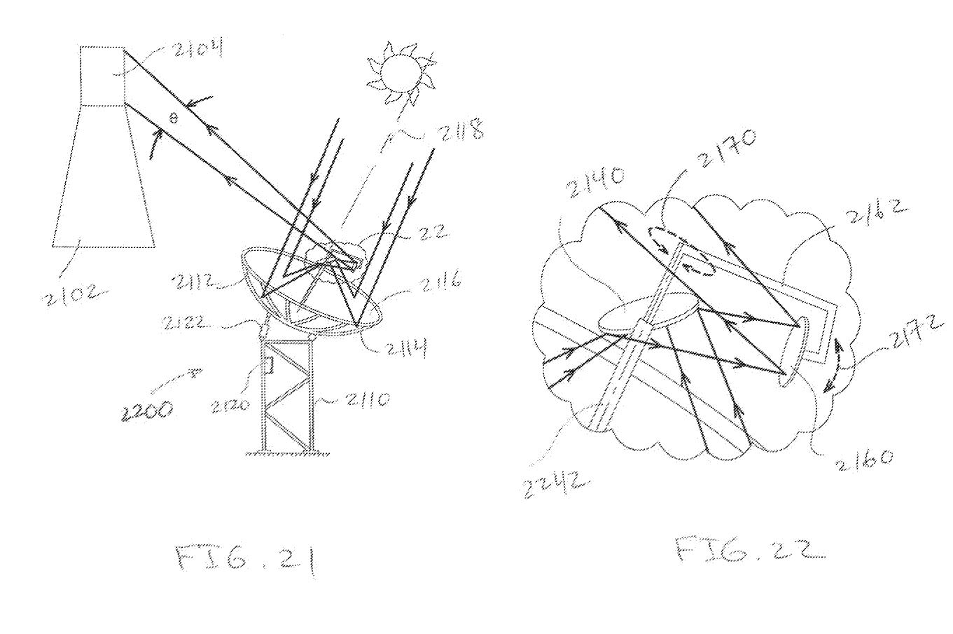

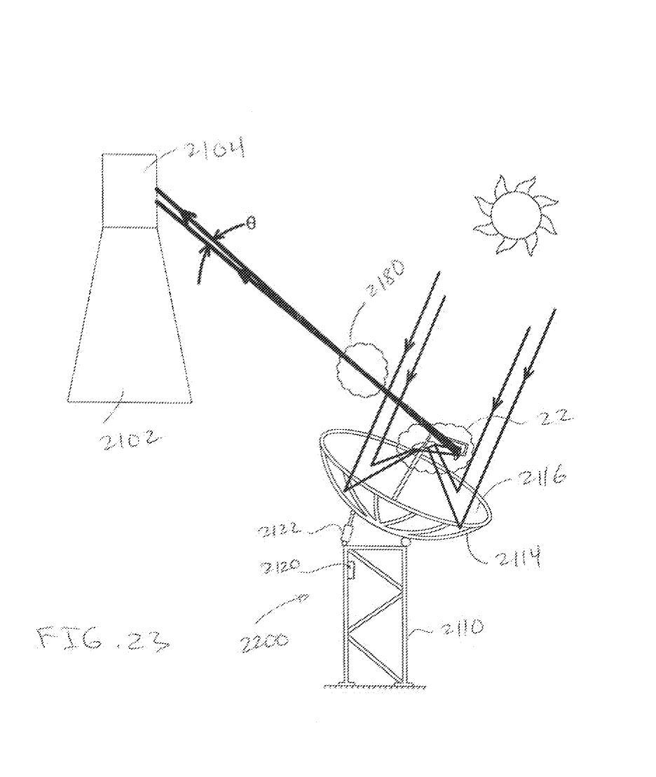

Referring to FIG. 21, a heliostat 2200 according to another embodiment is shown. The heliostat 2200 may be similar in many respects to the heliostat 2100. Accordingly, parts of the heliostat 2200 that are similar to the parts of the heliostat 2100 are referred to with the same reference numbers. Referring to FIG. 22, the heliostat 2200 includes a secondary reflector 2240 that is mounted generally at or proximate to the focal point of the primary reflector 2116. The secondary reflector 2240 may function both as a reflector to reflect converging solar rays that are focused onto the focal point by the primary reflector 2116 and as a collimator to redirect the converging solar rays into reflected parallel arrays. The curvature of the secondary reflector 2240 may be determined to provide the noted reflection and collimation function.

The heliostat 2200 further includes a tertiary reflector 2160 that is mounted proximate to the secondary reflector 2140 with a control arm 2162. The control arm 2162 is mounted to a support beam 2242 that extends along the reflector axis 2118 and is rotatable about the reflector axis 2118 as shown by the arrows 2170. The secondary reflector 2240 is mounted on the control arm 2162 and rotates with a control arm 2162 about the reflector axis 2118 as shown by the arrows 2170. Thus, the control arm 2162 and the secondary reflector 2240 rotate together as shown by the arrows 2170. The tertiary reflector 2160 is rotatable relative to the control arm as shown by the arrows 2172. Rotation of the control arm 2162 as shown by the arrows 217 and rotation of the tertiary reflector 2160 relative to the control arm 2162 may be controlled by one or more control system that are similar to the control system of the reflector assembly 2112 so as to provide 2-axis tracking for the tertiary reflector 2160.

As the reflector assembly 2112 tracks the sun, the position and orientation of the secondary reflector 2140 changes relative to the receiver 2104. Accordingly, the parallel arrays reflecting from the secondary reflector 2140 change direction during the daily operation of the reflector assembly 2112. The secondary reflector 2140 is affixed to and rotates with the control arm 2162. During daily operation of the heliostat 2200, the control arm 2162 rotates about the reflector axis 2118 to reflect focused solar rays from the primary reflector 2116 toward the tertiary reflector 2160 with the secondary reflector 2240. To direct the solar rays reflected from the secondary reflector 2240 toward the receiver 2104, the tertiary reflector 2160 rotates relative to the control arm 2162 as shown by the arrows 2172. Thus, the control arm 2162, the secondary reflector 2240 and the tertiary reflector 2160 rotate to maintain the solar rays reflected from the tertiary reflector 2160 onto the receiver 2104 throughout the daily operation of the reflector assembly 2112. The curvature of the tertiary reflector 2160 may be determined so that the solar rays reflected from the secondary reflector 2140 form a beam having a beam angle θ. The beam angle θ may be determined so that based on the distance of the heliostat from the tower 2102, the beam or the solar rays reflected from the tertiary reflector 2160 generally strike at least a portion of or the entire receiver 2104.

A heliostat 2200 may be positioned far from the receiver 2104 such that the beam angle θ may become too large when the reflected beam or solar rays reach the receiver 2104. Accordingly, only a portion of the beam may strike to receiver 2104. According to the embodiment shown in FIG. 23, the tertiary reflector 2160 may be configured in size and curvature so that the reflective solar rays intersect at a region 2280 between the tertiary reflector 2160 and the receiver 2104. Accordingly, a heliostat 2200 may be positioned far from the receiver 2104 and yet provide a beam angle θ for the reflective solar rays such that most of the reflective solar rays strike at least a portion or all of the receiver 2104. According to one example, the distance of the heliostat 2200 shown in FIG. 23 may be twice as large as the distance of the heliostat 2200 of FIG. 21 from the tower 2102. Therefore, the noted crossbeam configuration shown in FIG. 23 allows heliostats 2200 that use the crossbeam configuration to be placed far from the tower 2102 so as to provide a large heliostat field.

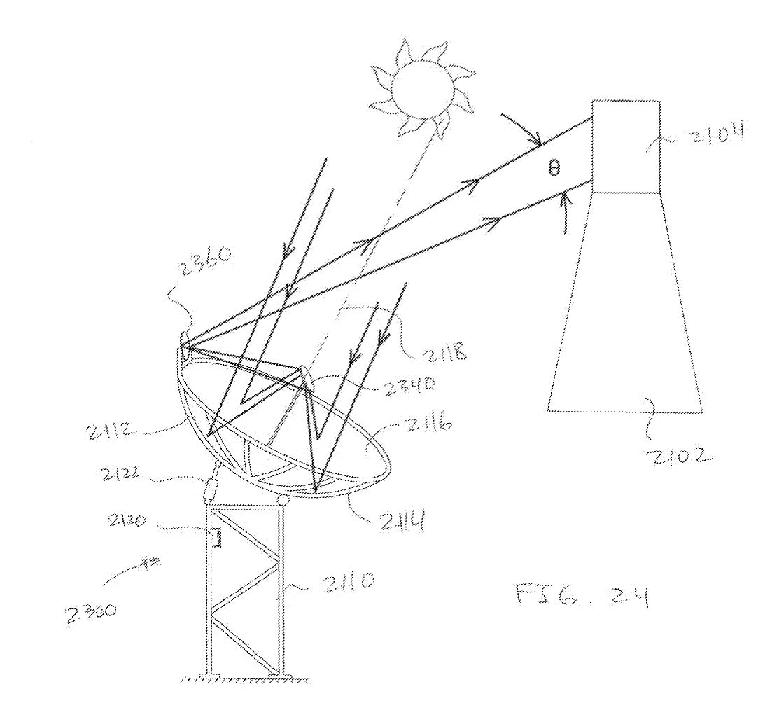

Referring to FIG. 24, a heliostat 2300 according to another embodiment is shown. The heliostat 2300 may be similar in many respects to the heliostat 2100. Accordingly, parts of the heliostat 2300 that are similar to the parts of the heliostat 2100 are referred to with the same reference numbers. The heliostat 2300 includes a secondary reflector 2340 that is mounted generally at or proximate to the focal point of the primary reflector 2116. The secondary reflector 2340 functions both as a reflector to reflect converging solar rays that are focused onto the focal point by the primary reflector 2116 and as a collimator to redirect the converging solar rays into reflected parallel arrays. The curvature of the secondary reflector 2340 may be determined to provide the noted reflection and collimation function.

The heliostat 2300 further includes a tertiary reflector 2360 that is mounted on or proximate to the rim of the reflector assembly 2112 or the reflector 2116. Accordingly, the tertiary reflector 2360 rotates with the frame assembly 2112. The location and orientation of the secondary reflector 2340 is fixed such that solar rays reflected from the secondary reflector 2340 are directed toward the tertiary reflector 2360. The tertiary reflector 2360 is rotatable in two axes to adjust the elevation and azimuth of the tertiary reflector 2360. Rotation of the tertiary reflector 2360 may be controlled by a control system similar to the control system used for the t-axis tracking of the primary reflector 2116. Thus, the tertiary reflector 2360 is also operated with 2-axis tracking. The curvature of the tertiary reflector 2360 is configured so that solar rays reflected from the tertiary reflector 2360 form a beam having a beam angle θ that strikes a portion or the entire receiver 2104. As described above, the reflector assembly 2112 rotates during the day to track the position of the sun. Accordingly, the position and orientation of the primary reflector 2116, the secondary reflector 2340 and the tertiary reflector 2360 change throughout the day. The control system of the tertiary reflector 2360 rotates the tertiary reflector 2360 throughout the day so that the solar rays or the beam reflected from the tertiary reflector 2360 are maintained on the receiver 2104 during the daily operation of the heliostat 2300.

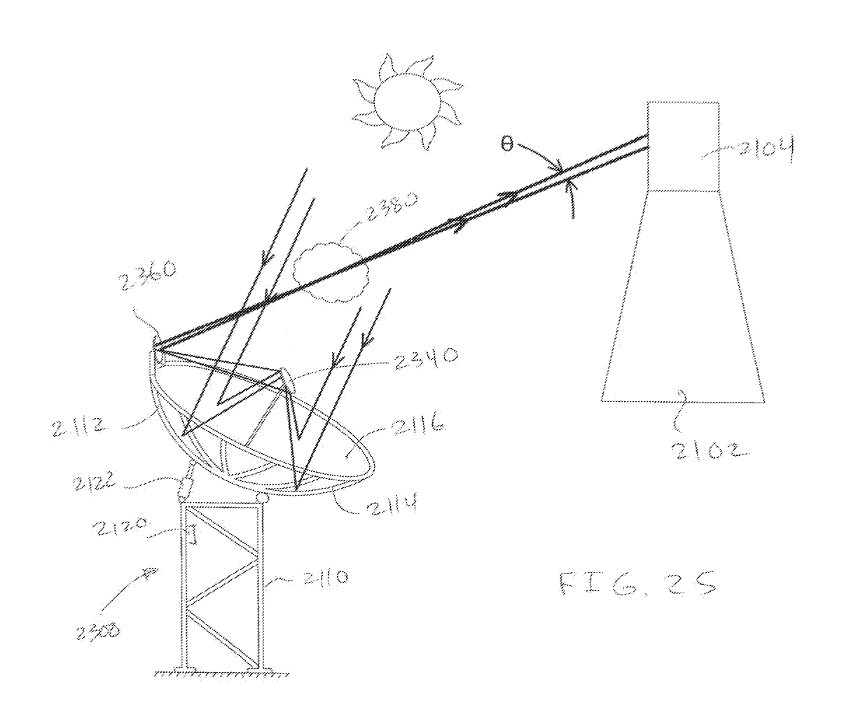

A heliostat 2300 may be positioned far from the receiver 2104 such that the beam angle θ may become too large when the reflected solar rays reach the receiver 2104. Accordingly, only a portion of the reflective solar rays may strike to receiver 2104. According to the embodiment shown in FIG. 25, the tertiary reflector 2360 may be configured in size and curvature so that the reflective solar rays intersect at a region 2380 between the tertiary reflector 2360 and the receiver 2104. Accordingly, a heliostat 2300 may be positioned far from the receiver 2104 and yet provide a beam angle θ for the reflective solar rays such that most of the reflective solar rays strike at least a portion or all of the receiver 2104. According to one example, the distance of the heliostat 2300 shown in FIG. 25 may be twice as large as the distance of the heliostat 2300 of FIG. 24 from the tower 2102. Therefore, the noted crossbeam configuration shown in FIG. 25 allows heliostats 2300 that use the crossbeam configuration to be placed far from the tower 2102 so as to provide a large heliostat field.

The heliostats 2100, 2200, and 2300 can provide a concentrated beam on the receiver 2104 as compared to a heliostat having a flat or slightly curved reflector, thereby generating greater heat at the receiver. Furthermore, the heliostats 2100, 2200, and 2300 can strike a receiver with a smaller and accurate beam, i.e., a beam that more accurately strikes a receiver, due to the two-axis tracking of the primary reflector, the secondary reflector and/or the tertiary reflector of the heliostats 2100, 2200, and 2300. Additionally, the heliostats 2100, 2200, and 2300 provide directing a concentrated beam from all or substantially all of the heliostats in a heliostat field throughout the day due to the two-axis tracking of the primary reflector, the secondary reflector and/or the tertiary reflector. In other words, the primary reflector may be facing away from the tower and pointing toward the sun, while the secondary and/or tertiary reflectors direct a concentrated beam toward the tower. Further yet, the heliostats 2100, 2200, and 2300 allow a heliostat field to be constructed on a non-flat or sloped terrain due to the ability of the heliostats to direct a concentrated beam toward a tower regardless of the horizontal and/or vertical position of the heliostat relative to the sun and the tower. For the forgoing reasons, a short tower and/or a smaller receiver may be used for a solar power generation system using a concentrated beam heliostat according to the disclosure as compared to a tower and receiver generally used with solar fields using heliostats having flat or slightly curved reflectors.

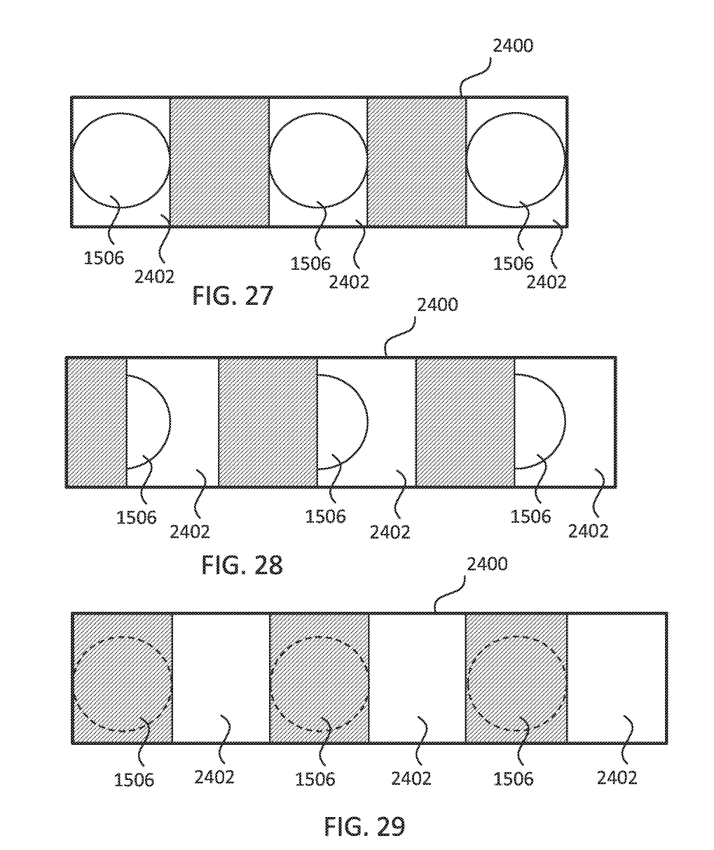

Referring to FIGS. 27-31, an example of a HTF flow constrictor or choke, which may be referred to herein as choke 2400 is shown. Referring to FIG. 27, the choke 2400 may be located between the receiver tubes 1506 and the drain tank 1504. In one example, the choke 2400 is circular structure, such as a plate, or a structure having a shape that is similar to the shape of the receiver 1500 and includes a plurality of through passages 2402. As described in detail below, the choke 2400 is rotatable relative to the receiver tubes 1506 or about the central axis M such that the passages 2402 may be moved relative to the receiver tubes 1506 to serve as flow control gates for HTC flowing from the receiver tubes 1506 to the drain tank 1504. Rotation of the choke 2400 may be controlled with one or more controllers and/or drives (not shown).

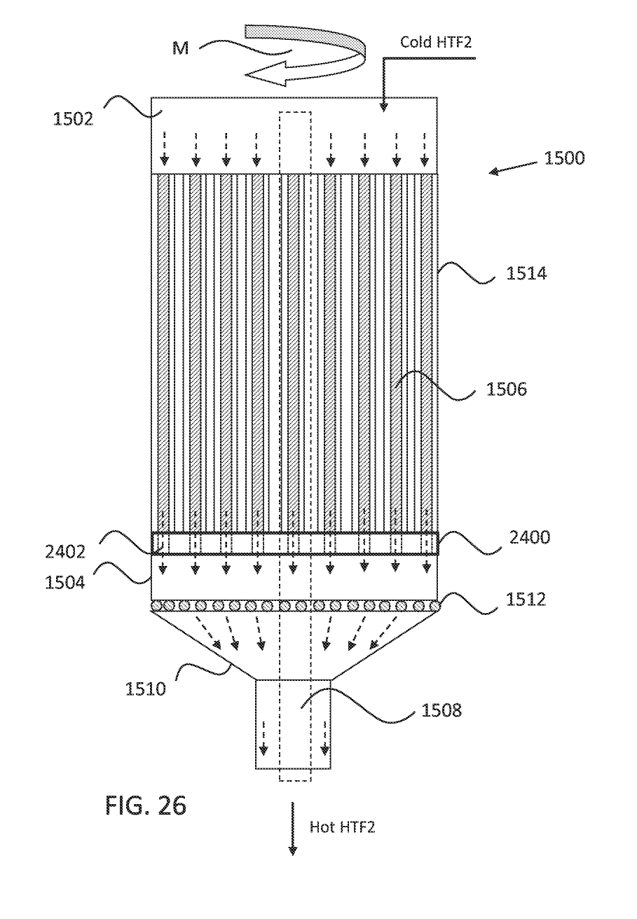

FIGS. 26 and 27 show a scenario where the choke 2400 is fully open. In other words the flow of HTC from the receiver tubes 1506 to the drain tank 1504 is not choked or constricted. In the fully open position of the choke 2400, the passages 2402 are fully aligned with the receiver tubes 1506. The passages 2402 may be in any shape such as circular, rectangular, or elliptical. In the examples of FIGS. 27-29 the passages 2402 are shown to be rectangular. Referring to FIG. 27, the passages 2402 are shown to be fully aligned with the receiver tubes 1506. Therefore, the HTC from the receiver tubes 1506 flows through the drain tank 1504 without any constriction from the choke 2400.

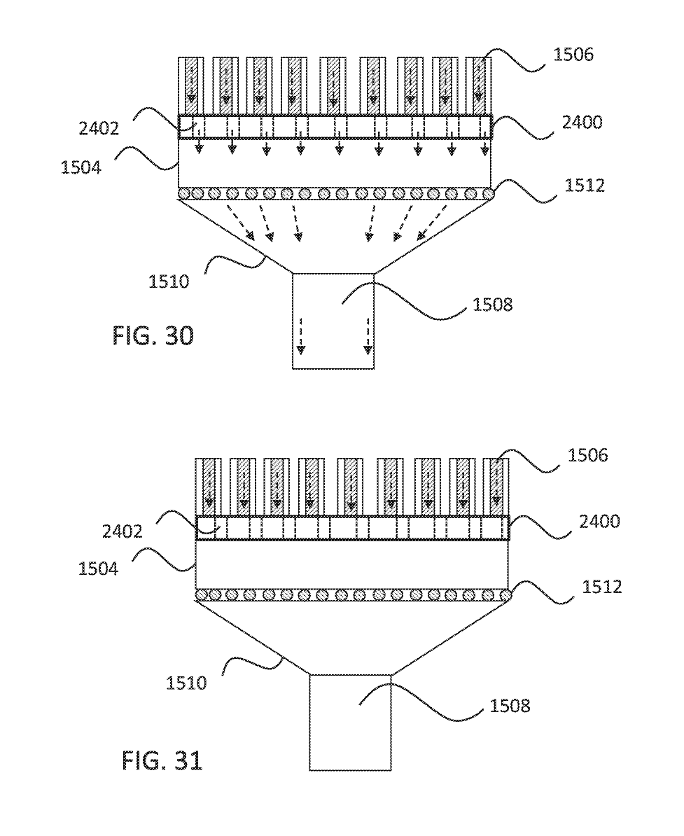

FIGS. 28 and 30 show a scenario where the choke 2400 is partially open. In other words, the flow of HTC from the receiver tubes 1506 to the drain tank 1504 is partially choked or constricted. In the partially open position of the choke 2400, the passages 2402 are partially aligned with the receiver tubes 1506. Therefore, the HTC from the receiver tubes 1506 is partially constricted or choked by the choke 2400. The degree by which the flow of HTC is constricted may depend on the position of the choke 2400 relative to the receiver tubes 1506. By rotating the choke 2400 relative to the receiver tubes 1506, the passages 2402 may be aligned with the receiver tube 1506 so as to block a preferred portion of the receiver tubes 1506. Rotation of the choke 2400 may be controlled by a controller and/or drive system (not shown). Accordingly, a preferred HTC flow rate through the receiver tubes 1506 may be achieved by controlling the amount of constriction of HTC flow from the receiver tubes 1506 to the drain tank 1504 with the choke 2400.

FIGS. 29 and 31 show a scenario where the choke 2400 is fully closed. In other words, the flow of HTC from the receiver tubes 1506 to the drain tank 1504 is fully choked or constricted. In the fully close position of the choke 2400, the passages 2402 are fully misaligned with the receiver tubes 1506. Accordingly, the spaces between the passages 2402 fully block the receiver tubes 1506 and prevent the HTC to flow from the receiver tubes 1506 to the drain tank 1504. In certain systems, certain leakage may exist due to manufacturing tolerances. The fully closed position of the choke 2400 may be used during the startup cycle of a solar power generation system to initially fill the receiver tubes 1506 with HTC and/or heat the HTC to a preferred temperature. Furthermore, the drive system of the choke 2400 may be used to adjust the flow rate of HTC through the receiver tubes 1506, thereby controlling the temperature of the HTC flowing to the drain tank 1504. For example, to reduce the temperature of the HTC flowing through the drain tank 1504, the choke 2400 may be further opened from its current position to increase the flow rate through the receiver tubes 1506. In contrast, to increase the temperature of HTC flowing to the drain tank 1504, the choke 2400 may be further closed from its current position to reduce the flow rate of HTC through the receiver tubes 1506.

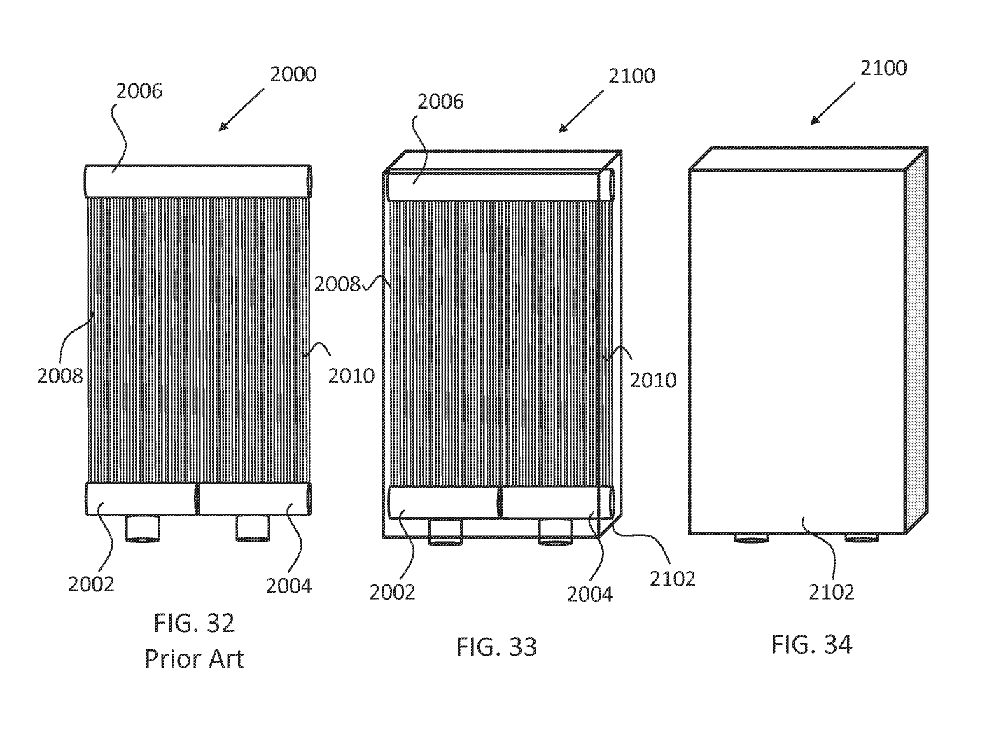

Referring to FIG. 32, a typical receiver panel module 2000 for a central tower receiver is shown. The receiver panel module 2000 includes an inlet header 2002, an outlet header 2004, and a top header 2006. The receiver panel module 2000 also includes a plurality of inlet tubes 2008 that connect the inlet header 2002 to the top header 2006 and a plurality of outlet tubes 2010 that connect the outlet header 2004 to the top header 2006. A central tower receiver typically includes a plurality of panel modules 2000 that are interchangeable with other panel modules. The inlet tubes 2008 and/or the outlet tubes 2010 may be separate, interconnected, have nonlinear shapes such as a coil shape to increase heat absorption of the heat transfer fluid from the inlet header 2002 to the outlet header 2004. For example, the inlet tubes 2008 may be defined by single tube that traverses between the inlet header 2002 and the top header 2006 in a continuing circuit. Thus, a central tower receiver includes a plurality of panel module 2000 arranged around or inside the tower receiver so that the inlet tubes 2008 and the outlet tubes 2010 absorb sunlight to heat the heat transfer fluid flowing through the inlet tubes 2008 and outlet tubes 2010. The receiver panel modules 2000 are interchangeable and/or replaceable. Accordingly, a single receiver panel module 2000 may be removed from a central tower and replaced with another receiver panel module 2000.

Referring to FIGS. 33 and 34, a receiver panel module 2100 according to one embodiment is shown. The receiver panel module 2100 is similar to the receiver panel module 2000. Accordingly, the receiver panel module 2100 includes an inlet header 2002, and outlet header 2004, a top header 2006, a plurality of inlet tubes 2008 that connect the inlet header 2002 to the top header 2006, and a plurality of outlet tubes 2010 that connect the outlet header 2004 to the top header 2006. Additionally, the receiver panel module 2100 includes a sealed enclosure 2102 that can be at least partially filled with a heat conduction fluid, which may be any type of heat conduction fluid. According to one embodiment, the inlet tubes 2008 and the outlet tubes 2010 are submerged in the head conduction fluid. According to one embodiment, the heat conduction fluid has a greater thermal conductivity than the heat transfer fluid in the inlet tubes 2008 and the outlet tubes 2010. According to one embodiment, the heat conduction fluid may be molten sodium. When the receiver panel module 2100 receives solar radiation or concentrated solar radiation from a plurality of heliostats, the enclosure 2102 is first heated and then the heat is transferred to the heat conduction fluid inside the enclosure 2102. Because the tubes 2008 and 2010 may be submerged in the heat conduction fluid, the surface areas of the tubes 2008 and 2010 are exposed to the heat conduction fluid. Thus, the heat in the heat conduction fluid is rapidly and efficiently transferred to the heat transfer fluid without inefficiencies associated with heat conduction and convection with the air surrounding the tubes 2008 in 2010.

Each receiver panel module 2100 may be manufactured prior to being transported to a solar thermal energy producing facility. For example, after manufacturing the above-described components of the receiver panel module 2100, the noted components may be mounted or installed in the enclosure 2102. Subsequently, the enclosure 2102 may be filled with a heat conduction fluid and then sealed. If molten sodium is used as the heat conduction fluid, the enclosure 2102 may be filled with the molten sodium prior to being sealed. The molten sodium may freeze at 97.72° C. (207.9° F.) after manufacturing of the receiver panel module 2100, which may then be transported to a solar thermal energy producing facility for installation in a central receiver tower. Upon installing each receiver panel module 2100, the sodium inside the enclosure 2102 will reach a molten state to provide operation of the central receiver as described herein.

The above-described configurations of the receiver panel module 2100 and the components thereof are exemplary. For example, a receiver panel module may include any number of inlets and outlets and associated headers, any configuration of continuous, segmented and or modular inlet and outlet tubes having different or similar cross-sectional shapes sizes and configurations, any enclosure shape such as rectangular as described above or other shapes for housing the components of the receiver panel module, and/or any type of heat conduction fluid that can accelerate the transfer of heat from the received solar radiation to the heat transfer fluid inside the receiver tubes as compared to, for example, convection by the air surrounding the receiver tubes.

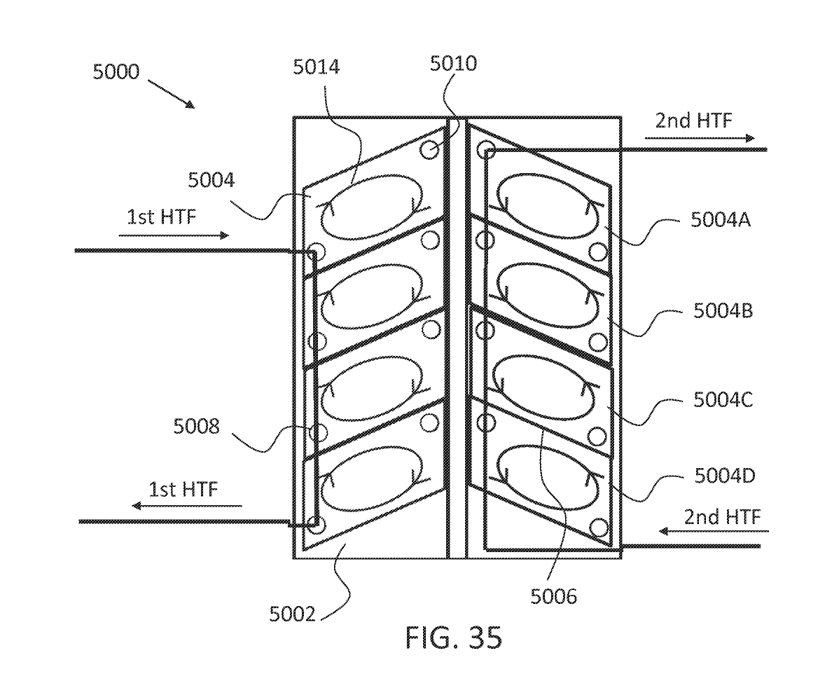

Referring to FIG. 35, an energy storage system 5000 according to one embodiment is shown. The energy storage system includes an energy storage tank 5002 (referred to herein as the tank 5002) having a plurality of stacked compartments (generally referred to herein as compartments 5004) that may be defined and separated by compartment dividers 5006. In the example of FIG. 35, the tank 5002 is shown to have four compartments 5004A, 5004B, 5004C and 5004D. However, any number of compartments may be used. The tank 5002 may have any shape. In the example of FIG. 35, the tank 5002 is annular. Accordingly, each compartment 5004 is annular. Further, as shown in FIG. 35, each compartment 5004 may be upwardly sloped from the perimeter portion of the tank 5002 toward the center of the tank 5002. Accordingly, each compartment 5004 may be cone shaped. The annular shape and cone shape of each compartment 5004 may promote convection flow of the fluid inside the compartment 5004 as described herein.

The energy storage system 5000 includes a first heat exchanger 5008 that is located inside the compartments 5004 near the perimeter of the tank 5002 and at a lower portion of each compartment 5004 as shown in FIG. 35. The first heat exchanger 5008 may have a coil-shaped conduit that wraps around inside the tank 5002 near the perimeter of the tank 5002 with a full or partial coil portion inside and in a lower portion of each compartment 5004. The first heat exchanger 5008 enters the tank 5002 from the top compartment 5004A, coils around the tank 5002 to traverse inside each compartment 5004, and exits the tank 5002 from the bottom compartment 5004D. The first heat exchanger 5008 may carry a first heat transfer fluid (HTF). Thus, the first HTF flows through the first heat exchanger 5008 from the top of the tank 5002 to the bottom of the tank 5002 to function as a circumferential heat exchanger.

The energy storage system 5000 includes a second heat exchanger 5010 that is located inside the compartments 5004 near the center of the tank 5002 and at an upper portion of each compartment 5004 as shown in FIG. 35. The second heat exchanger 5010 may have a coil-shaped conduit that wraps around inside the tank 5002 near the center of the tank 5002 with a full or partial coil portion inside and in an upper portion of each compartment 5004. The second heat exchanger 5010 enters the tank 5002 from the bottom compartment 5004D, coils around the tank 5002 near the center of the tank 5002 to traverse inside each compartment 5004, and exits the tank 5002 from the top compartment 5004A. The second heat exchanger 5010 may carry a second heat transfer fluid (HTF). Thus, the second HTF flows through the second heat exchanger 5010 from the bottom of the tank 5002 to the top of the tank 5002 to function as a core heat exchanger.

The compartments 5004 may be filled with a third HTF, which may be the same as or different than the first HTF and/or the second HTF. The third HTF may be any type of energy storage medium and/or be a gas, a liquid, a solid or a combination thereof. The dividers 5006 may prevent the third HTF from flowing between the compartments 5004. However, the dividers 5006 may be porous to allow some flow of the third HTF between the compartments 5004 depending on the porosity of the dividers 5006. The third HTF remains in the tank 5002 and neither flows out of the tank 5002 nor is removed from the tank 5002. In other words, the third HTF is contained and remains in the tank 5002 during the operation of the energy storage system 5000.

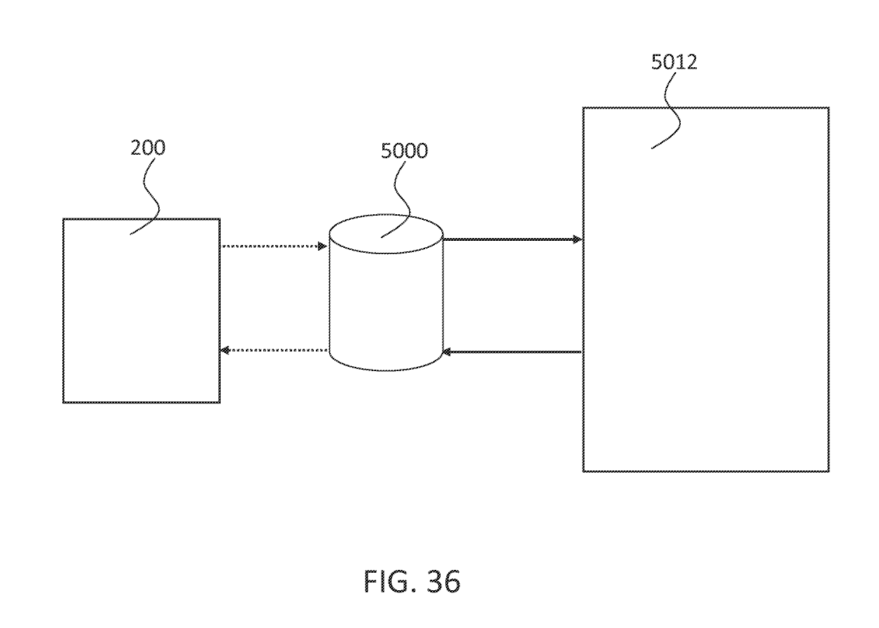

Referring also to FIG. 36, the first heat exchanger 5008 may be connected to a concentrated solar power or a solar reflective system, such as the trough system 200 of FIG. 4, by which the first HTF is heated to a temperature T for generating steam and thereby generating electricity with a steam turbine. The concentrated solar power or solar reflective system can be any type of system by which solar energy is converted into heat. In the following, the trough system 200 is used as an example of a solar reflective system or a concentrated solar power system to describe the energy storage system 5000. The temperature T may represent a range of operational temperatures or optimum useful temperatures for a power block or other applications. For example the range of temperature T may be 400-800° C. or 450-900° C. Thus, the temperature T is not limited to a single temperature and may represent a range of operational temperatures.

The first HTF flows through the first heat exchanger 5008 to heat the third HTF of the top compartment 5004A and subsequently the remaining compartments 5004B, 5004C and 5004D as the first HTF flows from the top of the tank 5002 to the bottom of the tank 5002. The third HTF is heated by the first HTF by thermal conduction through the walls of the first heat exchanger 5008. Accordingly, the third HTF of the top compartment 5004A may first reach temperature T, and subsequently the third HTF of the remaining compartments 5004B, 5004C and 5004D reach temperature T. Thus, the first HTF heats the compartments 5004A, 5004B, 5004C and 5004D of the tank 5002 from the top down.

The flow of the first HTF through portions of the first heat exchanger 5008 that are located in the compartments 5004 may be controlled by a plurality of valves (not shown). Accordingly, the first HTF may bypass any one or a plurality of the compartments 5004 as the first HTF flows through the first heat exchanger 5008. For example, as the first HTF enters the tank 5002, one or more valves located at a portion of the first heat exchanger 5008 that is upstream of the top compartment 5004A may be closed so that the first HTF bypasses the top compartment 5004A. In another example, one or more valves located at a portion of the first heat exchanger 5008 that is downstream of the top compartment 5004A and upstream of the compartment 5004B may be closed so that the first HTF bypasses the top compartment 5004A and the adjacent compartment 5004B. Therefore, the first HTF may bypass any one or multiple compartments 5004.

The second HTF flows through the second heat exchanger 5010 to absorb the heat from the third HTF inside one, several or all of the compartments 5004. The flow of the second HTF through portions of the second heat exchanger 5010 that are located in the compartments 5004 may be controlled by a plurality of valves (not shown). Accordingly, the second HTF may bypass any one or a plurality of the compartments 5004 as the second HTF flows through the second heat exchanger 5010. For example, as the second HTF enters the tank 5002, a valve located at a portion of the second heat exchanger 5010 that is upstream of the bottom compartment 5004D may be closed so that the second HTF bypasses the bottom compartment 5004D. In another example, a valve located at a portion of the second heat exchanger 5010 that is downstream of the bottom compartment 5004D and upstream of the compartment 5004C may be closed so that the second HTF bypasses the bottom compartment 5004D and the adjacent compartment 5004C. Therefore, the second HTF may bypass any single one or multiple compartments 5004.

As the flow of the first HTF through the first heat exchanger 5008 heats the third HTF, the heated third HTF rises inside each compartment from a location near the first heat exchanger 5008 to the top portion of the compartment. However, as the flow of the second HTF through the second heat exchanger 5010 absorbs heat from the third HTF, the cooled third HTF flows back toward the bottom portion of the compartment. Accordingly, a convective flow circuit 5014 may be established inside each of the compartments 5004A, 5004B, 5004C and 5004D due to the locations of the first heat exchanger 5008 and the second heat exchanger 5010 and/or the shape of each compartment. Thus, the first HTF heats the third HTF inside the compartments 5004A, 5004B, 5004C and/or 5004D to the temperature T from the top down, and the second HTF is heated to the temperature T by the third HTF inside the compartments 5004D, 5004C, 5004B and/or 5004A from the bottom up. The heated second HTF is then transferred via the second heat exchanger 5010 to a power block 5012 to generate electricity.

The second heat exchanger 5010 may be connected to a power block 5012, which may be any type of power block including any of the power blocks described herein. For example, a power block may include a steam generator, a steam turbine that operates by using the generated steam, and an electrical generator that generates electricity by being operated with the steam turbine. In another example, a power block may include only a steam generator for generating steam for oil extraction from oil wells. The second HTF is provided to the power block 5012 from the energy storage system 5000. The thermal energy from the second HTF is used to generate steam and/or electricity.

The energy storage system 5000 provides storage of thermal energy in the tank 5002 so that the stored thermal energy can be used during discontinuous or intermittent operation of the trough system 200. Discontinuous or intermittent operation may refer to, for example, intermittent cloudiness so that the through system cannot continuously heat the first HTF to the temperature T, the trough system 200 being inoperative for short periods due to maintenance, equipment upgrade or repairs, and/or the trough system 200 being unable to heat the first HTF to the temperature T for any reason. Normal operation of a trough system 200 may refer to continuous operation during sunny conditions.

The energy storage system 5000 also provides as output constant flow of the second HTF at a constant temperature to the power block 5012 for producing steam at a constant pressure and temperature with an input of the first HTF at variable flow and constant usable temperature. Thus, in addition to functioning as a thermal storage or battery, the energy storage system 5000 also functions as a flow and temperature regulator between the trough system 200 and the power block 5012.

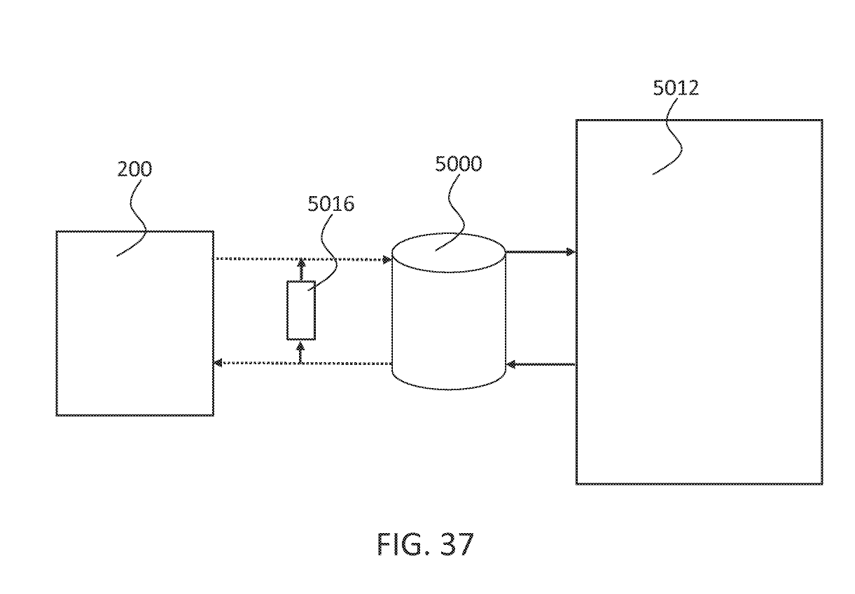

During normal operation of a solar power generation system, the third HTF in all of the compartments 5004A, 5004B, 5004C and 5004D of the tank 5002 is heated to the temperature T. Thus, all of the compartments 5004A, 5004B, 5004C and 5004D may include the third HTF at the temperature T. As described herein, the third HTF is continuously heated by the first HTF and the heat in the third HTF is then continuously transferred to the second HTF to generate electricity. During short periods of intermittent operation of the trough system 200, the second HTF is heated by the third HTF from the compartment 5004D in a direction toward compartment 5004A. In other words, the second HTF is heated by the third HTF in the tank 5002 from the bottom up. For example, the third HTF in all of the compartments may be at temperature T during normal operation. According to one example, the sky over the solar power generation system may then turn partly or fully cloudy. Accordingly, the third HTF flowing into the tank 5002 from the trough system 200 through the first heat exchanger 5008 may not be at the temperature T. However, the third HTF in all of the compartments 5004 is at temperature T. The second HTF entering the tank 5002 through the second heat exchanger 5010 is heated by the third HTF in the bottom compartment 5004D until the temperature of the third HTF is below the temperature T. The second HTF is then heated by the compartment 5004C until the temperature of the third HTF in the compartment 5004C falls below the temperature T. The heating of the second HTF by the third HTF may continue until the temperature of the third HTF in the top compartment 5004A is below the temperature T. Thus, the third HTF of compartments 5004D, 5004C, 5004B and 5004A sequentially heats the second HTF flowing in the second heat exchanger to continue operation of the power block 5012 to generate electricity despite the trough system 200 being intermittently operable or inoperable. Referring to FIG. 37, if the trough system 200 is inoperable for an extended period of time, the energy storage system 5000 may include a heater 5016 to heat the first HTF to the temperature T to continue operation of the power block 5012 to generate electricity. The heater 5016 may be electric or fossil fuel powered.

When the intermittent operation of the solar power generation system ceases, the second HTF, which reaches temperature T, flows through the first heat exchanger 5008 from the top of the tank 5002 to the bottom of the tank 5002 to sequentially heat the third HTF in the compartments 5004A, 5004B, 5004C and 5004D. Further as described herein, the third HTF in each compartment may heat the third HTF in an adjacent compartment by conduction and/or convection depending on the porosity of the dividers 5006. As the third HTF in the compartments are heated from the top down, the second HTF flowing through the second heat exchanger 5010 is heated to the temperature T from the bottom up. In other words, the second HTF in the second heat exchanger 5010 is heated sequentially by the third HTF in the bottom compartment 5004D and then by the third HTF in the compartments 5004C, 5004B and 5004A. The bottom up heating of the second HTF allows the second HTF to receive heat from the bottom compartment 5004D and then sequentially from compartments 5004C, 5004B and 5004A as needed. For example, the bottom compartment 5004D may not have sufficient thermal energy to heat the second HTF to a temperature T. The second HTF is then further heated by the compartments 5004C, 5004B and/or 5004A until the second HTF reaches the temperature T. For example, the second HTF may be heated to the temperature T by the compartments 5004D and 5004C. Accordingly, using the compartments 5004A and 5004B to heat the second HTF may not be necessary. Thus, the valves of the second heat exchanger 5010 may control the flow or the second HTF through the compartments 5004 to control the heating of the second HTF.

The valves of the second heat exchanger 5010 may also provide steady inlet conditions for a steam turbine of the power block. Thus, depending on the status of the first HTF flowing through the first heat exchanger 2008, the status of the third HTF in each compartment 5004, and the status of the second HTF flowing through the second heat exchanger 2010, the valves of the second heat exchanger 5010 can be modulated to provide steady inlet conditions for a steam turbine of a power block to provide steady and/or optimum power generation. A control system including a plurality of sensors may be used to sense the conditions at the inlet of the steam turbine and conditions at various locations in the energy storage system 5000. The control system can then use the sensor data to modulate the plurality of valves of the second heat exchanger 5010 to provide steady inlet conditions for the steam turbine.

The size of the tank 5002, the size of each compartment 5004 and/or the number of compartments may be configured depending on energy storage requirements of the solar power generation system and/or the environmental factors for the location at which the solar power generation system is installed. For example, historical weather data for a particular location may be used to configure the energy storage system 5000. For locations that are more prone to having longer cloudy periods during the day, a larger tank 5002 with more compartments may be configured. In contrast, for locations that have long sunny periods during the day, a smaller tank 5002 with fewer compartments may be configured. Depending on configuration of the solar energy system installed at a certain location and the environmental factors of that location, each compartment may be configured to provide an approximately fixed period of storage energy. For example, each compartment may be configured to provide one hour of thermal storage. According, the tank 5002 of the example of FIG. 35 may provide four hours of energy storage.

According to one example, the first HTF and/or the second HTF may be synthetic mineral oil that may be heated to a temperature T. The third HTF may be molten salt, which is contained in the tank 5002 and remains in the tank 5002. The temperature of the molten salt may drop below the melting point of the salt causing the salt to solidify without impairing any operation or serviceability of the solar energy storage system 5000. Such freezing of the third HTF may be caused by a drop in the temperature of the first HTF, which may be the result of a solar power generation system, such as the trough system 200, becoming inoperable. The frozen third HTF remains in the tank 5002 until the first HTF is heated again to an operable temperature, such as the temperature T, by the trough system 200. The first HTF then transfers heat to the third HTF to melt the third HTF and raise the temperature of the third HTF to the temperature T as described herein. Such a process may occur during prolonged inoperability of a solar power generation system due maintenance, repair, equipment upgrade and/or irregular or unusual weather phenomena.

As described herein, the dividers 5006 defining the compartments may completely separate the third HTF in each compartment. For example, the dividers may be constructed from metal or the same material from which the tank 5002 is constructed. Alternatively, the dividers 5006 may be porous to allow limited movement of the third HTF between the compartments. For example, the dividers 5006 may be constructed from certain fabric that can operate in the temperature ranges of the third HTF. The third HTF in each compartment provides heat transfer to the third HTF in adjacent compartments by heat conduction through the dividers 5006. However, if the dividers are porous, the heat transfer between the third HTF of adjacent compartments may also include heat transfer by convection.

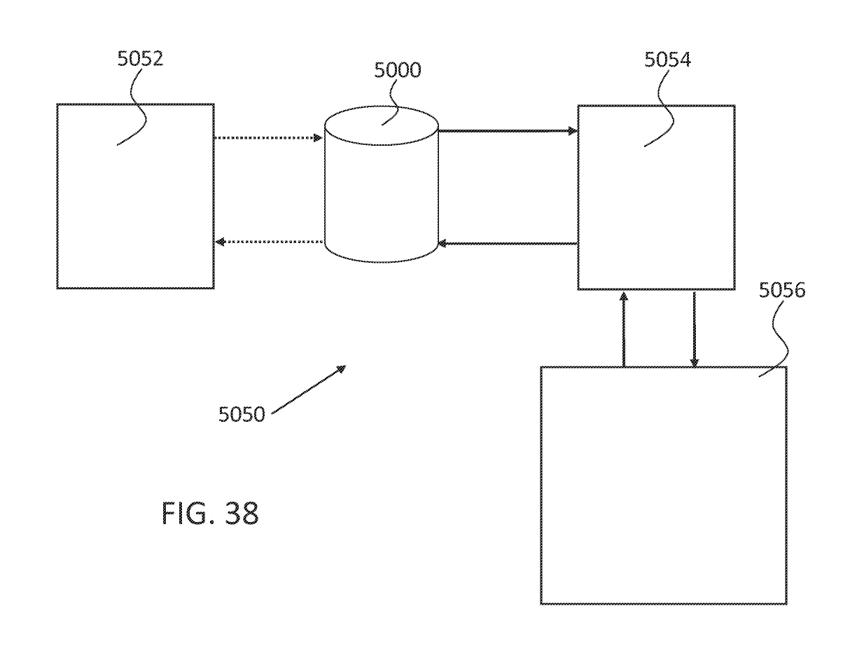

Referring to FIG. 38, a solar power plant 5050 using the energy storage system 5000 according to one embodiment is shown. The solar power plant 5050 includes a first concentrated solar power (CSP) system 5052 (e.g., a trough system) and a second CSP system 5054. The energy storage system 5000 is operationally positioned between the first CSP system 5052 and the second CSP system 5054 to function as energy storage and regulator as described herein. In other words, the energy storage system 5000 provides energy storage to the solar power plant 5050 and provides heat transfer fluid to the second CSP system 5054 at constant flow and temperature as described herein. The second CSP is then connected to a power block 5056 to generate steam and/or electricity.

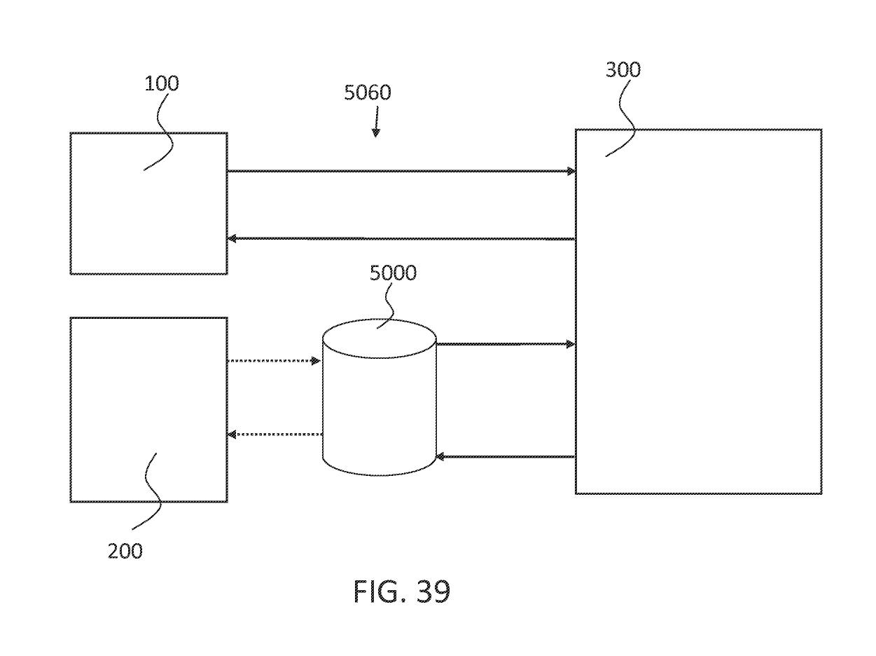

Referring to FIG. 39, a solar power plant 5060 using the energy storage system 5000 according to one embodiment is shown. The solar power plant 5060 may be similar in many respects to the solar power plant 50 of FIG. 2. Therefore, same parts are referred to with the same reference numbers. The energy storage system 5000 is operationally positioned between the trough system 200 and the power block 300 to function as energy storage and regulator as described herein. In other words, the energy storage system 5000 provides energy storage to the solar power plant 50 and provides HTF1 at constant flow and temperature to the power block 300 as described herein. The operation of the solar power plant 5060 is described in detail herein and is not repeated with respect to the embodiment of FIG. 39.

Although not shown, the energy storage system 5000 can be used at any one or multiple locations in a solar power plant where energy storage, HTF flow and temperature regulation may be preferred or needed. For example, referring to FIG. 5, the energy storage system 5000 may be located inside the power block 300 between one or more components or to replace any of the heat exchangers in the power block 300.

Although a particular order of actions is described above, these actions may be performed in other temporal sequences. For example, two or more actions described above may be performed sequentially, concurrently, or simultaneously. Alternatively, two or more actions may be performed in reversed order. Further, one or more actions described above may not be performed at all. The apparatus, methods, and articles of manufacture described herein are not limited in this regard.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. An energy storage system comprising:
a plurality of stacked compartments;
a first heat exchanger having an first heat exchanger input in an upper compartment of the plurality of stacked compartments, a first heat exchanger output in a lower compartment of the plurality of compartments, and a first heat exchanger body located proximate to a lower perimeter portion of each compartment of the plurality of stacked compartments, the first heat exchanger carrying a first heat transfer fluid from the first heat exchanger input to the first heat exchanger output through the first heat exchanger body;
a second heat exchanger having a second heat exchanger input in an upper compartment of the plurality of compartments, a second heat exchanger output in a lower compartment of the plurality of compartments, and a second heat exchanger body located proximate to a lower perimeter portion of each compartment of the plurality of stacked compartments, the second heat exchanger carrying a second heat transfer fluid from the second heat exchanger input to the second heat exchanger output through the second heat exchanger body; and
a third heat transfer fluid in the plurality of compartments exchanging heat with the first heat transfer fluid through the first heat exchanger and exchanging heat with the second heat transfer fluid through the second heat exchanger.

2. The energy storage system of claim 1, wherein the first heat exchanger comprises coils through center portions of the plurality stacked compartments from the first heat exchanger input to the first heat exchanger output.

3. The energy storage system of claim 1, wherein the second heat exchanger comprises coils extending through perimeter portions of the plurality of stacked compartments from the second heat exchanger input to the second heat exchanger output.

4. The energy storage system of claim 1, wherein each of the stacked compartments of the plurality of compartments is annular.

5. The energy storage system of claim 1, wherein each of the stacked compartments of the plurality of compartments is cone-shaped.

6. The energy storage system of claim 1, wherein each stacked compartment of the plurality of compartments is fluidically separated from an adjacent stacked compartment of the plurality of stacked compartments.

7. The energy storage system of claim 1, wherein the first heat transfer fluid at the first heat exchanger input has a higher temperature than the second heat transfer at the second heat exchanger input.

8. A solar power plant comprising:
a first solar reflective system configured to heat a first heat transfer fluid to a temperature within a first temperature range;
at least a second solar reflective system coupled to the first solar reflective system, the second solar reflective system having a second heat transfer fluid comprising a different material than the second heat transfer fluid and configured to be heated to a temperature within the first temperature range by the first heat transfer fluid, the second solar reflective system configured to heat the second heat transfer fluid to a temperature within a second temperature range; and
an energy storage system comprising:
a plurality of stacked compartments;
a first heat exchanger having a first heat exchanger input in an upper compartment of the plurality of stacked compartments, a first heat exchanger output in a lower compartment of the plurality of compartments, and a first heat exchanger body located proximate to a lower perimeter portion of each compartment of the plurality of stacked compartments, the first heat exchanger carrying the first heat transfer fluid from the first heat exchanger input to the first heat exchanger output through the first heat exchanger body;
a second heat exchanger having a second heat exchanger input in an upper compartment of the plurality of compartments, a second heat exchanger output in a lower compartment of the plurality of compartments, and a second heat exchanger body located proximate to a lower perimeter portion of each compartment of the plurality of stacked compartments, the second heat exchanger carrying the second heat transfer fluid from the second heat exchanger input to the second heat exchanger output through the second heat exchanger body; and
a third heat transfer fluid in the plurality of compartments exchanging heat with the first heat transfer fluid through the first heat exchanger and exchanging heat with the second heat transfer fluid through the second heat exchanger.

9. The solar power plant of claim 8, further comprising a power generation system coupled to the first solar reflective system and the second solar reflective system and configured to generate electricity by receiving heat from the second first heat transfer fluid and the second heat transfer fluid, wherein the power generation system comprises:
a steam generator configured to generate a first steam with heat from the first heat transfer fluid;
a superheater configured to generate a second steam from the first steam with heat from the second heat transfer fluid; and
wherein the second steam has higher energy than the first steam.

10. The solar power plant of claim 8, further comprising a power generation system coupled to the first solar reflective system and the second solar reflective system and configured to generate electricity by receiving heat from the second first heat transfer fluid and the second heat transfer fluid, wherein the power generation system comprises:
a steam generator configured to generate a first steam with heat from the first heat transfer fluid;
a superheater configured to generate a second steam from the first steam with heat from the second heat transfer fluid;
a steam turbine configured to operate with the second steam; and
wherein the second steam has higher energy than the first steam.

11. The solar power plant of claim 8, further comprising a power generation system coupled to the first solar reflective system and the second solar reflective system and configured to generate electricity by receiving heat from the second first heat transfer fluid and the second heat transfer fluid, wherein the power generation system comprises:
a steam generator configured to generate a first steam from water with heat from the first heat transfer fluid;
a superheater configured to generate a second steam from the first steam with heat from the second heat transfer fluid;
a steam turbine configured to operate with the second steam;
a reheater located downstream of the steam turbine and configured to reheat steam downstream of the steam turbine with the first heat transfer fluid downstream of the superheater; and
wherein the second steam has higher energy than the first steam.

12. The solar power plant of claim 8, further comprising a power generation system coupled to the first solar reflective system and the second solar reflective system and configured to generate electricity by receiving heat from the second first heat transfer fluid and the second heat transfer fluid, wherein the power generation system comprises:
a steam generator configured to generate a first steam with heat from the first heat transfer fluid;
a superheater configured to generate a second steam from the first steam with heat from the second heat transfer fluid;
a first steam turbine configured to operate with the second steam;
a reheater located downstream of the first steam turbine and configured to reheat steam downstream of the first steam turbine with the first heat transfer fluid downstream of the superheater;
a second steam turbine configured to operate with the reheated steam; and
wherein the second steam has higher energy than the first steam.

13. A receiver system for a solar power plant comprising:
an enclosure configured to hold a first heat transfer fluid;
a receiver in the enclosure and at least partially submerged in the first heat transfer fluid, the receiver including an inlet portion, an outlet portion, and a plurality of tubes connecting the inlet portion to the outlet portion to carry a second heat transfer fluid from the inlet portion to the outlet portion.

14. The receiver system of claim 13, wherein the first heat transfer fluid and the second heat transfer fluid comprise the same material.

15. The receiver system of claim 13, wherein the first heat transfer fluid and the second heat transfer fluid comprise different materials.

16. The receiver system of claim 13, wherein the first heat transfer fluid and the second heat transfer fluid are molten salt.

17. The receiver system of claim 13, wherein the first heat transfer fluid and receiver tubes are sealed inside the enclosure.

18. The receiver system of claim 13, wherein the receiver tubes are fully submerged in the first heat transfer fluid.
